(19) United States
(12) Patent Application Publication
(10) Pub. No.: US 2024/0211730 A1
(43) Pub. Date: Jun. 27, 2024

(54) SYSTEMS AND METHODS FOR A MACHINE LEARNING FRAMEWORK FOR CHARACTERIZING MACROSCALE BEHAVIOR AND DESIGNS

(71) Applicants: Sara Walker, Scottsdale, AZ (US); Yanbo Zhang, Tempe, AZ (US)

(72) Inventors: Sara Walker, Scottsdale, AZ (US); Yanbo Zhang, Tempe, AZ (US)

(73) Assignee: Arizona Board of Regents on Behalf of Arizona State University, Tempe, AZ (US)

(21) Appl. No.: 18/544,102

(22) Filed: Dec. 18, 2023

Related U.S. Application Data
(60) Provisional application No. 63/433,247, filed on Dec. 16, 2022.

(51) Int. Cl. G06N 3/045

(52) U.S. Cl. CPC G06N 3/045

(57) ABSTRACT

A computer-implemented framework (MacroNet) automatically identifies macroscale behaviors in complex systems and samples specific instances that exhibit the behavior. Applied to complex systems, this allows an automated method for identifying predictive regularities in data via dimensionality reduction to just a few variables (macrostates), that also then allows the capability to design a new system outside the original training data that exhibits the same macroscale behavior. The framework enables automated discovery of macroscale descriptions of complex systems, design of systems that have the specified macroscale description by sampling microstates consistent with the identified macrostates, and predicting behaviors at the macroscale when accurate predictions for specific systems are not possible.

### CROSS-REFERENCE TO RELATED APPLICATIONS

This is a U.S. Non-Provisional Patent Application that claims benefit to U.S. Provisional Patent Application Ser. No. 63/433,247 filed 16 Dec. 2022, which is herein incorporated by reference in its entirety.

### FIELD

The present disclosure generally relates to artificial neural networks, and in particular, to a system and associated method for an artificial neural network framework for identifying macroscale behavior and designing new microstates with the macroscale behavior.

### BACKGROUND

The ability to predict, design and control systems stems from the ability to reduce dimensionality to a few key variables that accurately capture or otherwise characterize much of the behavior of the system. In theoretical physics, this has led to some of the most precise predictions ever made and the ability to control physical systems also with high precision. However, in complex systems, such as biological and technological systems, this degree of predictability or control is not available due to high dimensionality; it is a daunting task for human scientists to identify the relevant reduced variable set to describe them accurately. Complex systems present two major challenges when trying to formulate a reduced description of their behavior: (1) they are high-dimensional (much higher than physical systems, meaning the same old tools cannot be applied and new ones are needed); and (2) the mapping at micro-scale can be many-to-many mapping. For example, the same “rule” can generate many results, and different “rules” can also lead to the same result. This means the mappings are themselves probabilistic, which makes accurate prediction impossible. An example of the latter is genotype to phenotype maps, where there are many genotypes with a given phenotype and the phenotypic landscape is itself dynamic such that many phenotypes can correspond to the same genotype, depending on environment. The genotype-phenotype map is not fully iterable because it is too computationally expensive to model all genotypic space, so identifying relevant reduced descriptions that capture features of this map would be a major advance.

It is with these observations in mind, among others, that various aspects of the present disclosure were conceived and developed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A-1C are a series of diagrams showing comparison between causal state theory, causal emergence theory and relational macrostate theories;

FIGS. 2A-2C are a series of diagrams demonstrating that macrostates are defined by symmetries that define relations between ensembles of microstates in which FIG. 2A shows an optimal solution, FIG. 2B shows a trivial but legal solution, which coarse grains all microstates to the same macrostate and FIG. 2C shows an inconsistent solution;

FIGS. 3A-3B are a series of diagrams showing a neural network architecture and the sampling process after they have been trained;

FIG. 3C shows a coarse-graining and sampling process;

FIG. 3D shows a detailed structure of RealNVP;

FIGS. 4A-4D are a series of graphical representations showing training neural networks to find macrostates and design microstates of linear dynamical systems in which both the parameters and trajectories are coarse-grained to two-dimensional macrostates according to various systems described herein;

FIGS. 5A-5C are a series of graphical representations showing training of a neural network with a simple harmonic oscillator to find invariant quantities as a special case of macrostates, where FIGS. 5B and 5C demonstrate that invariants found by a neural network can have a clear and monotonous relation to the energy and demonstrating that sampling the microstate from given macrostate, the neural network is able to sample circles;

FIG. 6 is a graphical representation showing experiments on Turing patterns;

FIGS. 7A and 7B are a pair of graphical representations showing relations that are represented by joint distributions and conditional distributions respectively;

FIGS. 8A-8D are a series of illustrations showing multiple versions of invertible neural networks (INNs);

FIGS. 9A-9D are a series of graphical representations showing how noisy kernel can improve performance when input dimension is too low, where

FIGS. 9A and 9C show results without noisy kernel and FIGS. 9B and 9D show results with noisy kernel;

FIGS. 10A-10F are a series of graphical representations showing changes in behavior of a linear dynamical system based on values within a matrix;

FIGS. 11A and 11B are a pair of graphical representations showing that a trained neural network according to FIGS. 4A-4D is capable of predicting a macrostate;

FIGS. 12A-12F are a series of graphical representations showing trajectories, microstates and dynamics (in which red lines show the example trajectories, gray dotted lines show the sampled microstates of trajectories, and blue vector lines represent the dynamics of sampled parameters);

FIGS. 13A-13C are a series of simplified diagrams showing a neural network structure for finding macrostates adopting noisy kernel;

FIG. 14 is a simplified diagram showing a training process for finding invariants as macrostates from simple harmonic oscillators;

FIGS. 15A-15C are a series of simplified diagrams showing a neural network structure for finding macrostates of simple harmonic oscillators;

FIG. 16 is a simplified diagram showing a training process for finding macrostates from Turing patterns;

FIGS. 17A-17D are a series of simplified diagrams showing a neural network structure for finding macrostates of Turing patterns.

FIGS. 18A and 18B are a pair of graphical representations showing that the neural network of FIGS. 17A-17D is capable of predicting the macrostate;

FIG. 19 is a graphical representation showing sampling of patterns with same macrostates by a first inverse function;

FIG. 20 is a graphical representation showing sampling of patterns with same macrostates by a first inverse function;

FIG. 21 is a simplified diagram showing an example computing system for implementation of the systems outlined herein; and

FIGS. 22A and 22B are a pair of process flow diagrams illustrating a method for learning mappings from microstates to macrostates, and for using the learned mappings to generate example microstates.

Corresponding reference characters indicate corresponding elements among the view of the drawings. The headings used in the figures do not limit the scope of the claims.

### DETAILED DESCRIPTION

The present disclosure provides a description of a computer-implemented framework (e.g., “MacroNet”) that implements a general-purpose machine-learning based model for identifying predictive macroscale properties of complex systems. A major advance is that the framework also allows the design of new systems that exhibit those same properties. In this context, “macrostates” are reduced-dimensionality descriptors that are predictive of a complex system, while “microstates” are high-dimensional descriptors that include the full detail of a specific instance of the complex system. The framework automatically “learns” predictive macrostates and can sample microstates that are derived from a given macrostate. In contrast to other frameworks in similar fields, the framework does not directly predict microstates, but instead predicts features of the entire ensemble of microstates consistent with a given macrostate. This has broad applications, including weather prediction, financial market prediction and other time series predictions, where the framework can enable prediction of future behavior based on identified macroscale behavior, and allows sampling of microstates that are consistent with observed macroscale data. The latter can be important, particularly in complex and chaotic systems where minor variations in microscale knowledge can hinder long-term predictability. The framework can also be implemented in complex system design, such as nanotechnology design, medicine design, chemical design and other design problems that require automated parameter design and sampling based on the identified parameters.

Current machine-learning based methods either aim to directly predict microstates, or to identify macrostates without the ability to design microstates. In contrast, the framework described herein predicts macrostates and retains information to sample microstates with the specified behavior. This allows the framework to predict distributions of microstates rather than just one microstate. Further, current state-of-the-art neural network models are trained by direct prediction of microstates; in other words, these models require detailed knowledge of a complex system to make predictions. Contrastive learning algorithms also do not directly predict microstates but rely on macroscale descriptors. However, contrastive learning does not have the capability for design and sampling—when a microstate is identified it cannot allow sampling of new microstates nor does it have the generative ability to produce them. In contrast, the framework described herein can both identify macrostates and sample parameters of a complex system to allow design of new microstates with the specified macroscale behavior.

### 1. Summary

A system outlined herein includes a processor in communication with a memory, the memory including instructions executable by the processor to: apply an example microstate instance of a microstate space as input to a neural network to obtain an example macrostate of the example microstate instance, the neural network being one of a first neural network having learned a first mapping between a first microstate space of a microstate pair and a first macrostate, and a second neural network having learned a second mapping between a second microstate space of the microstate pair and a second macrostate; and sample, by the neural network, an ensemble of sampled microstate instances of the first microstate space or the second microstate space that correspond to the example macrostate, the neural network being an invertible neural network. The first microstate space and the second microstate space can each include observation data about a physical system, where the first microstate space corresponds with a first type of observation data about the physical system, and where the second microstate space corresponds with a second type of observation data about the physical system.

In other words, the system can take an “example” microstate instance (e.g., a trajectory that describes motion of a particle) belonging to a first or second microstate space, and can determine an “example” macrostate that the “example” microstate instance can be classified under, using a mapping learned by a first neural network or a second neural network (where both the first neural network and the second neural network have been jointly trained). With knowledge of the “example” macrostate that the “example” microstate instance correlates with, the system can do one or more of: sample microstate instances from another microstate space that would also correlate with the “example” macrostate (e.g., a set of parameters that would result in a particle following trajectories having similar shapes); and/or sample microstate instances from the same microstate space that would also correlate with the “example” macrostate (e.g., realistic trajectories that have similar shapes). For sampling, the neural network can be an invertible neural network. While the example provided in this paragraph is discussed in terms of particle trajectories, further examples and adaptations are provided herein that show how the system can be applied to other physical systems such as time-invariant systems or complex Turing patterns.

Further, training the first neural network and the second neural network characterizes the first mapping and the second mapping without needing prior knowledge of macrostates for a physical system. The system achieves this by ensuring that results of mappings for jointly distributed microstate pairs (e.g., a set of parameters, and a set of particle trajectories that correlate directly with the set of parameters) are substantially close to one another. In other words, if a first microstate instance belonging to the first microstate (e.g., an n-th set of parameters) has a mapping to a first macrostate, and a second microstate instance belonging to the second microstate (e.g., an n-th particle trajectory) has a mapping to a second macrostate, and the first microstate instance correlates with the second microstate instance (e.g., the n-th set of parameters and the n-th particle trajectory are associated with the same particle and the n-th set of parameters have a direct effect on the n-th particle trajectory), then it can be said that the first macrostate and the second macrostate are substantially equivalent. Since the macrostates may be unknown to the system, the macrostates can be found or otherwise identified by the act of training the first neural network and the second neural network to find the first mapping and the second mapping. As such, when training the first neural network and the second neural network, the system needs to ensure that the second microstate space can be correlated with the first macrostate, and the first microstate space can be correlated with the second macrostate. Further, the training process needs to ensure that the system avoids trivial solutions.

As such, the memory can further include instructions executable by the processor to: provide a set of training data as input to the first neural network and the second neural network, the set of training data including a plurality of training microstate pairs, where each respective training microstate pair of the plurality of training microstate pairs includes a first training microstate instance belonging to the first microstate space and a second training microstate instance belonging to the second microstate space; and jointly train the first neural network to learn the first mapping and train the second neural network to learn the second mapping using the set of training data, such that a difference between the first macrostate and the second macrostate is minimized for each training microstate pair of the plurality of training microstate pairs of the set of training data. In a further aspect, training the first neural network and the second neural network can include iteratively determining parameters of the first neural network and the second neural network that minimize a loss function incorporating: a prediction loss between results of the first mapping and the second mapping for each training microstate pair of the plurality of training microstate pairs, where the first microstate space is related to the second microstate space by a joint distribution; and a distribution loss that enforces the first mapping and the second mapping to each have a nonzero Jacobian determinant. The prediction loss ensures that the resultant mappings are compatible with one another and that both the first neural network and the second neural network may be used for predicting corresponding microstates that belong to a different microstate space based on an example microstate, or for sampling additional microstate instances from either microstate space. The distribution loss ensures that solutions found are non-trivial and informative. Further, calculation of the distribution loss may be more computationally efficient when the first and second neural networks are invertible neural networks due to the unique abilities of invertible neural networks to easily evaluate the Jacobian determinant.

In a further aspect, a method outlined herein that may be implemented by a computing system can include: providing a set of training data as input to a first neural network and a second neural network, the set of training data including a plurality of training microstate pairs, where each respective training microstate pair of the plurality of training microstate pairs includes a first training microstate instance belonging to a first microstate space and a second training microstate instance belonging to a second microstate space; and jointly training the first neural network to learn a first mapping between the first microstate space and a first macrostate and training the second neural network to learn a second mapping between the second microstate space and a second macrostate using the set of training data, such that a difference between the first macrostate and the second macrostate is minimized for each training microstate pair of the plurality of training microstate pairs of the set of training data. The step of jointly training the first neural network and the second neural network can include iteratively determining parameters of the first neural network and the second neural network that minimize a loss function incorporating: a prediction loss between results of the first mapping and the second mapping for each training microstate pair of the plurality of training microstate pairs, where the first microstate space is related to the second microstate space by a joint distribution; and a distribution loss that enforces the first mapping and the second mapping to each have a nonzero Jacobian determinant.

Further, the method can include: applying an example microstate instance of the first microstate space or the second microstate space as input to the first neural network or the second neural network; determining an example macrostate of the example microstate instance using the first neural network or the second neural network; and sampling an ensemble of sampled microstate instances of the first microstate space or of the second microstate space that correspond to the example macrostate. For sampling, the corresponding first or second neural network should be an invertible neural network.

When the example microstate instance belongs to the first microstate space, the sampling step can include: inverting the first neural network; and sampling, by application of the example macrostate as input to the first neural network, the ensemble of sampled microstate instances of the first microstate space that correspond to the example macrostate. Conversely, then the example microstate instance belongs to the second microstate space, the sampling step can include: inverting the second neural network; and sampling, by application of the example macrostate as input to the second neural network, the ensemble of sampled microstate instances of the second microstate space that correspond to the example macrostate.

### 2. Introduction

Among the most important concepts in physics is that of symmetry, and how symmetry-breaking at the microscale can give rise to macroscale behaviors. This deep connection was made clearest in the work of Noether, where she showed that for differentiable systems with conservative forces, every symmetry comes with a corresponding conversation law that describes macroscale behavior. An example is how time translation symmetry gives rise to the conservation of energy: simple harmonic oscillators conserve energy because, in the absence of friction, you will observe the same oscillation if starting a clock at the first cycle as at the thousandth—the behavior is time invariant. Thus, Noether's theorem provided a means to relate laws—namely, regularities that are conserved (e.g., energy conservation)—to symmetries in the underlying physical system (e.g., time). Physics has been incredibly successful at discovering laws in this manner. However, so far, finding similar ‘law-like’ behaviors for complex systems, such as biological and technological ones, has proved much more challenging because of their high-dimensionality, non-linear behavior, and emergent properties. Yet, the very concept of emergence provides a clue that such regularities should exist, even for complex systems. In Anderson's seminal work on why “more is different”, he pointed to how symmetry-breaking also plays a prominent role in emergence: macroscale behaviors do not necessarily share all the same symmetries as the microscale laws or rules that give rise to them. While some of the symmetries are clearly lost, this also leaves open the possibility that large-scale patterns that emerge will still retain other symmetries of the microscale rules. In addition to the rule-behavior mapping, there are other mappings unique to complex systems such as genotype-phenotype maps, text-image maps, etc., where symmetries may lead to conserved properties. The challenge to identifying general laws for complex systems then reduces to identifying which symmetries are preserved during the mapping—in general this is challenging because of their high dimensionality, suggesting that machine learning might be an approach that can aid in identifying conservation laws in these systems, if macrostates and the symmetries they retain from the microscale can be identified.

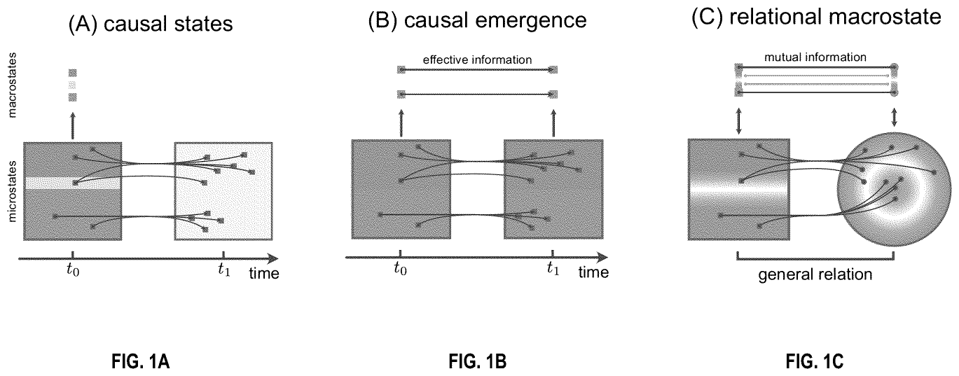

There have been several efforts focused on identifying macrostates associated with the emergent regularities found in complex systems. Notably, Shalizi and Moore proposed causal state theory, which defines macrostates based on the relations between microstates. Here, two microstates are equivalent (belong to the same macrostate) if the future microstates distributions are the same (FIG. 1A). Thus, the conserved symmetry is one pertaining to the prediction of future states. This, however, can exclude some well-defined macrostates in physics. For example, given a simple harmonic oscillator, two distinct microstates u₁=(p₁, x₁) and u₂=(p₂, x₂), where p₁ and p₂ are two observations of momentum and x₁ and x₂ are corresponding positions, can have the same energy macrostate. However, their future microstate distributions will be different if u₁ and u₂ are not close to each other, say if, u₁=−u₂. The conserved symmetry of Shalizi and Moore is therefore violated because this system does not retain predictability of future microstate distributions at the macroscale (because the macrostate of energy is related to the time translation symmetry, not the symmetry associated to predictability of future states).

If a proposed theory to define macrostates is not sufficiently general to include simple physical examples like the harmonic oscillator, it is unlikely to apply universally to complex systems. Indeed, Shalizi and Moore were not looking for a general theory of macrostates, but instead focused on the specific property of predictability of complex systems. Another approach was more recently proposed in causal emergence theory, which likewise has a specific goal in mind—to describe causal relations at the macroscale. Here, instead of using the properties of microstates, macrostates are defined based on the relations between macrostates by maximizing effective information at the macroscale. Effective information is the mutual information between two variables, under intervention to set one of them to maximum entropy (e.g., a uniform distribution over macrostates). Causal emergence occurs when the past and future of different macrostates are distinguishable (FIG. 1B). Thus, the symmetry of distinguishing past and future leads to a conservation of distinguishability of macrostates.

Both causal state theory and causal emergence theory define macrostates in terms of temporal relations between past and future. However, not all regularities that could be associated with laws involve time. For instance, to get the macrostates of mass, force, and acceleration, physicists of past generations needed to study the relations between two objects rather than between points in time (past and future). This suggests that to develop a general theory of macrostates, these must be defined based on general relations between two observations (FIG. 1C) that retain some of the symmetries of the underlying sets of observations—those observations could be objects, or points in time, as physics has already treated. But they can also be any other observation one can make with a measuring device, including more “complex” examples like genotype-phenotype maps, or word co-occurrence in language, or rule-behavior mapping necessary to describe patterning in biological form. The theory of macrostates discussed herein is sufficiently general to extend to the symmetry of the microscale level rules (or laws), which allow identification of sets of microscale rules that yield a given emergent, macroscale behavior.

When studying the history of the laws of physics, it is important to identify why the most successful laws have worked so well. Newton's laws of motion work because there is a macroscale property called mass, which quantifies the amount of matter in each object, that reduces the description of the motion of high dimensional objects to a single measurable scalar quantity (mass) and its translation in x, y, z coordinates. For complex systems it is not so obvious what the necessary dimensionality reduction will be that allows identifying law-like behavior, and it may vary from system to system. Of note, Newton's laws cannot be developed in a world where mass can only be defined and measured in a few countable objects and is undefined or unmeasurable in others. The present disclosure shows how artificial neural networks, themselves a complex system, can break the barrier of complexity to identify macrostates based on symmetries in complex systems. Existing machine learning methods such as contrastive learning, contrastive predictive coding, and word2vec have applied similar ideas to find lower dimensional representations for microstates by relations. However, these contrastive methods either require large numbers of negative samples that increases the cost of training, or only learning embeddings instead of functional mappings. Moreover, these methods are only useful for downstream tasks, which use the embedding trained by contrastive learning. Although some things are described herein at the macroscale, the world still runs on microscale features. This means that it is necessary to not only map microstates to macrostates, but also to provide an inverse path that samples microstates from a given macrostate. By developing the macrostate theory on general relations, and introducing invertibility, the present disclosure provides a machine learning architecture, MacroNet, that can learn macrostates and design microstates.

In fact, a key feature of learning is demonstrating use cases of the knowledge learned. Therefore, to demonstrate how MacroNet is indeed learning the macrostates across of examples of simple physical systems and complex systems; MacroNet is also used to design new examples. There has been a flurry of recent work by scientists attempting to engineer “AI scientists”, and in particular AI physicists, that can learn the laws of nature from data with minimal supervision. Examples include: AI Feynman, which learns symbolic expressions; AI Poincare that can learn conservation laws; and Sir Isaac, an inference algorithm that can learn dynamical laws. Yet, science as done by scientists goes further than solely extracting laws from data—humans also implement that understanding in the real world. For example, the knowledge of Newton's laws of motion has enabled people to engineer a range of systems, such as the design of airbags, racecars, airplanes, helicopters and even optimization of athlete performance, etc. Thus, further advancements beyond artificial intelligence that can learn the rules by which data behave could require AI that can also use that knowledge to design new examples of systems that will behave by the rules identified. A critical aspect of designing new examples of systems is identifying macrostate variables that reduce high-dimensional data to a few variables that capture the salient features. The invertibility of MacroNet not only allows the design of microstates sampled from an identified macrostate, but also provides a low-cost way to replace negative samplings in contrastive learning.

In what follows, the present disclosure introduces the mathematics of the framework for defining macrostates in terms of relations defined by symmetries in the data. Then, the present disclosure describes a machine learning framework to find macrostates under the definition. For experiments, the workflow of the framework is demonstrated by implementation for linear dynamical systems. They are simple enough to demonstrate key concepts, but also exhibit rich behaviors. Then, the present disclosure introduces the simple harmonic oscillator as a special case where macrostates are defined based on temporal relations, which demonstrates how the framework can extract familiar invariant macrostates (conserved properties associated to symmetries) from physics, such as energy. Finally, the present disclosure provides an example of a real complex system in the form of the macroscale Turing patterns that arise in diffusion reaction systems. The present disclosure further shows how machine learning finds the macrostates associated with the emergent patterning in these systems, and then how this can be used to design microstates consistent with a target macroscale pattern.

### 3. Theory and Method

### 3.1 The Relational Macrostate Theory Generalizable to the Study of Complex Systems Using Neural Networks

By definition, a macrostate is an ensemble corresponding to an equivalence class of microstates. Given a mapping φᵤ that maps microstates to macrostates, two microstates u and u′ belong to the same equivalence class if φᵤ(u)=φᵤ(u′), that is if the microstates have the same behavior (macrostate) under the operation of the map. In this way, macrostates are also the parameters to describe distributions of microstates. This feature is a key reason why machine learning may be an optimal way to identify macrostates, particularly in cases of many-to-many mappings such as those that occur in rule-behavior maps, or under prediction with noise, both of which are characteristic of complex systems.

Here, a formalism is implemented based on using relations arising due to symmetries to define macrostates. Consider two microstates u∈U and v∈V as two random variables. Their micro-to-micro relation can be mathematically represented as a joint distribution P(u, v). The u and v can be mapped to macrostates α and β respectively by φᵤ and φᵥ. So, the micro-to-macro relation can also be defined by the joint distribution P (α, v) and P(u, β). For a given microstate uᵢ (or vᵢ), its micro-to-macro relation can be represented as a conditional distribution Pᵣ(β|uᵢ) (or Pᵣ(α|vᵢ)). Then, macrostates in the most (relational) general case can be defined as:

Definition 1. Two pairs of microstates uᵢ and uⱼ (and vᵢ and vⱼ) belong to the same macrostate if and only if they have the same micro-to-macro relation:

$${u}_{i} ∼ {u}_{j} ⇔ P r ( β \vert {u}_{i} ) = P r ( β \vert {u}_{j} ) and \qquad ( 1 )$$

$${v}_{i} ∼ {v}_{j} ⇔ P r ( α \vert {v}_{i} ) = P r ( α \vert {v}_{j} ) \qquad ( 2 )$$

Note, this defines an equivalence class of symmetries where uᵢ˜uⱼ and vᵢ˜vⱼ (where ˜ indicates “is equivalent to” under the symmetry operation). Thus, as in Noether's theorem (and in Anderson's formalization of emergence) it is shown that the definition of a macrostate entails simultaneously defining a class of symmetry operations, although here the definition is sufficiently general that the system of interest need not necessarily be continuously differentiable (as in the case of Noether's theorem).

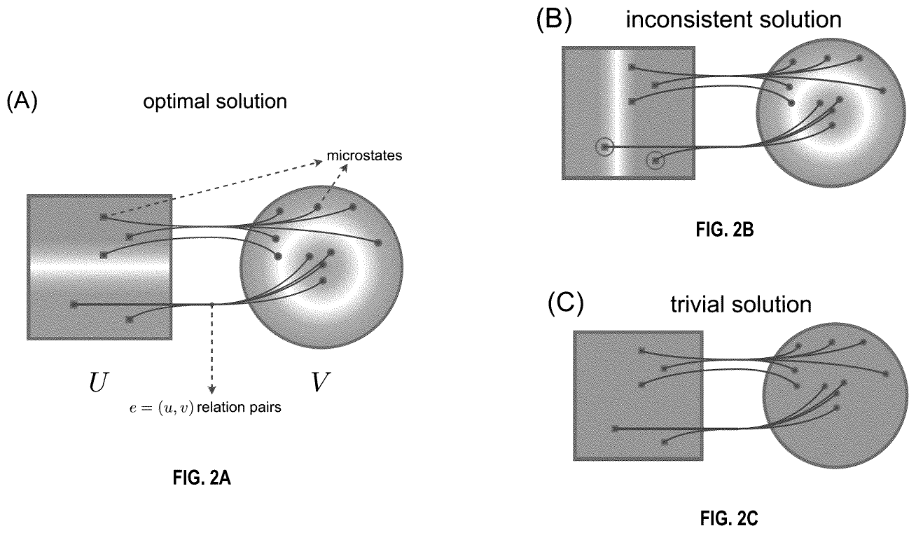

The definition can be approached by solving φᵤ(u)=φᵥ(v). This equation will be part of the loss function in the specified machine learning task of MacroNet. Since the macrostate of U is defined by the macrostate of V, and vice versa, the solutions are not computed in a straightforward way, but must be calculated in relation to one another. As such, there can exist some inconsistent solutions. FIG. 2A shows a consistent solution, however, FIG. 2B shows an inconsistent solution. The points in red circles are classified into two macrostates, while they both have the same micro-to-macro relation. Not all consistent solutions are useful. If all microstates are mapped to the same macrostate, it still follows the definition, but this is a trivial solution and not informative, see FIG. 2C. In addition to definition 1, an information criterion is required to specify “good macrostates” by specifying a given dimension of macrostates, and then maximizing the mutual information I (φ(v); φ(u)) at the macroscopic level, where (u, v) is sampled from P(u, v). As a comparison, the effective information (EI) in causal emergence theory also uses the mutual information concept, but it has notable differences in how it is implemented beyond the fact that the theory presented here was designed for a machine learning implementation and causal emergence was not. In a discrete macrostate space, to quantify the causal effect, the EI re-assigns the marginal distribution of the macrostates with a uniform distribution. This requirement is not made since causal relations are not the focus. Moreover, in a continuous macrostate space, the causal relation between macrostates may not make much sense because of the large number of different macrostates.

### 3.2 A Self-Supervised Generative Model for Finding Macrostates From Observations

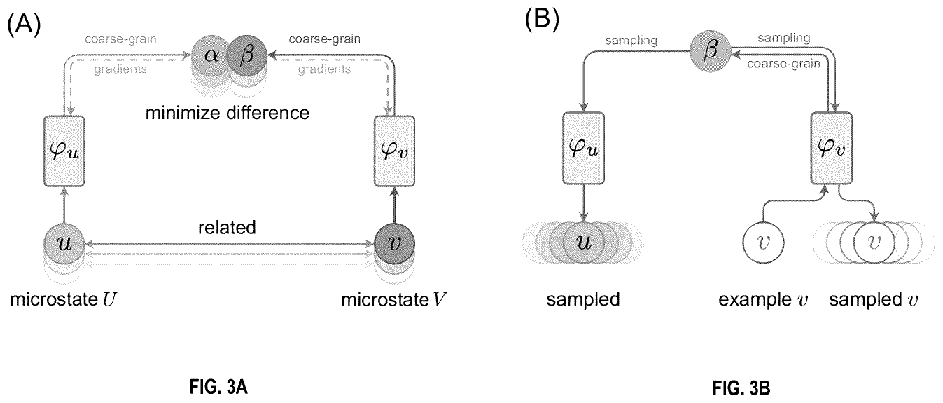

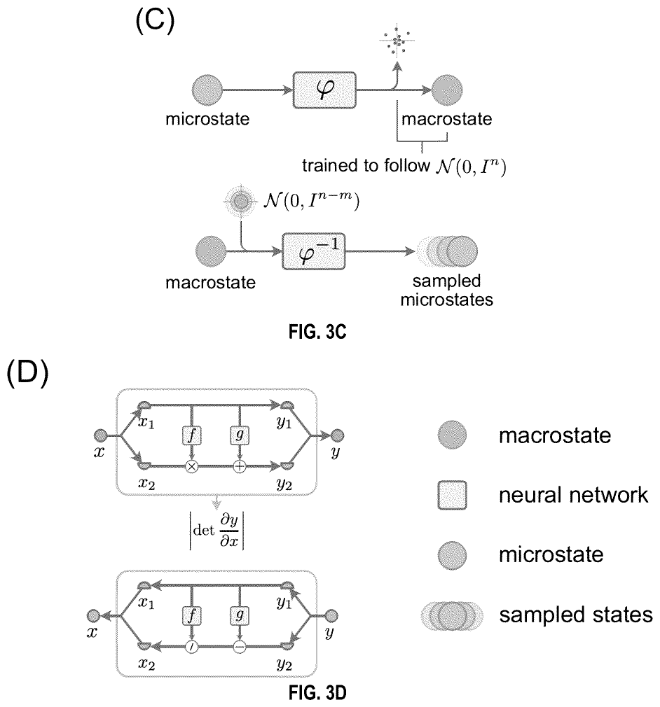

In the above formalization, a macrostate in U is defined by macrostates in V (i.e., macrostates are defined only in terms of their relations to other macrostates). This relational definition necessitates that the macrostate mapping should be iteratively optimized to find an optimal solution. Thus, to implement the relational macrostates theory, a self-supervised generative model is disclosed herein for finding macrostates from observations (FIG. 3A).

The definition of macrostates can be achieved by optimizing macrostates to predict other macrostates. Here φᵤ and φᵥ are used to represent the coarse graining performed by the neural networks on U and V respectively. The prediction loss is:

[symbol]

_{P}= [symbol] _{(u,v)˜P(u,v)}|φᵤ(u)−φᵥ(v)|², (3)

where (u, v) are pairs of microstates sampled from the training data. The ideal solution for φ is φᵤ(u)≈_{σ}φᵥ(v) , meaning the macrostate of u can be predicted by the macrostate of v with error of σ, and vice versa. However, an additional term is needed to avoid trivial solutions such as a low dimensional manifold or constant. To do this, a distribution loss is added, [symbol] _{D}= [symbol] _{D}_{ᵤ}+ [symbol] _{D}_{ᵥ}, where:

$${ℒ}_{{D}_{u}} = log {P}_{n o r m a l} ( {φ}_{u} ( u ) ) - log \vert det \frac{\partial {φ}_{u} ( u )}{\partial u} \vert , \qquad ( 4 )$$

$${ℒ}_{{D}_{v}} = log {P}_{n o r m a l} ( {φ}_{v} ( v ) ) - log \vert det \frac{\partial {φ}_{v} ( v )}{\partial v} \vert . \qquad ( 5 )$$

The distribution loss is be minimized when the outputs follow independent normal distributions. The neural networks are trained by combining the two loss functions:

$$ℒ = {ℒ}_{P} + {γℒ}_{D} , \qquad ( 6 )$$

where γ is the hyperparameter balancing the two loss terms. Combining these two terms, one can approach the mutual information criterion. Directly computing [symbol] _{D} can be very expensive since it requires computing the Jacobian. However, since sampling is a goal of this disclosure, invertible neural networks (INNs) can help. The INNs are not only designed to be invertible, but also designed to easily compute the log-determinate of the Jacobian. The INNs will have the same output dimension as the input, so part of the dimensions can be abandoned. For example, if one wants to map an 8-dimensional vector to two-dimensional macrostate, the INNs will still give an 8-dimensional vector as a result, but only the first two variables are taken as the macrostate for training. The abandoned six variables, however, still have been trained to follow independent normal distributions so conditional inverse sampling can be applied.

Given an example microstate v′, suppose one wants to find other microstates in V space with the same macrostate as v′. φᵥ(v′) can be used to compute the macrostate β of the example v′. Then, the neural network can be inverted to sample microstates vₛ that have the same macrostates. This conditional sampling allows identifying the symmetry of macrostates and enables the design of microstates by sampling from a given target macrostate once the network is trained on other examples with the same macroscale behavior (FIG. 3B). This kind of sampling can enable the design of complex systems: the identified macrostates are not given by humans, but instead, computed from examples by neural networks. This process makes it possible to design complex systems without needing to first classify their behavior.

### 4. Results

In what follows, three explicit examples of the application of MacroNet are considered. The first is a linear dynamical system, which enables demonstration of the key features of the workflow of the framework with a system that allows easily demonstrating key concepts, via the identification of a rotational symmetry and design of microstates consistent with this behavior. The second example is a simple harmonic oscillator (SHO), where MacroNet is demonstrated to identify a familiar symmetry and its corresponding macrostate in physics—time translation invariance and energy—by showing that the workflow can identify equal energy surfaces for the SHO. The final example is Turing patterns, where the utility of MacroNet is shown in solving the inverse problem of mapping macro-to-micro in a complex system.

### 4.1 Linear Dynamical Systems

This section starts with an experiment analyzing a linear dynamical system because these have many-to-many mappings. This enables demonstration of the workflow of identifying macrostates based on symmetries and then designing microstates from the identified macrostates. Here, a two-dimensional linear dynamical system is selected whose dynamics are given by:

$$\frac{d \vec{x}}{dt} = M \vec{x} , \qquad ( 7 )$$

where x is the independent variable, and M is a 2×2 matrix that includes the parameters that specify the dynamics of the system. Given a matrix M and an initial state x₀, a sequence of observed states can be generated by computing xₜ₊₁=Xₜ+Mxₜδt. The trajectory will be T=[x₁, x₂, . . . , xₙ] in the two-dimensional space, where n=8 and δt=1/n. Here n=8 is selected because it is large enough to show the pattern of trajectories and not too large to slow the training. In this example, the micro-to-micro relations are represented by parameter-trajectory pairs, i.e., (u, v)=(M,T). Note, in contrast to more standard approaches to studying dynamical systems, the present methods described herein do not necessarily aim to find a macrostate by coarse graining the trajectory of states (which would depend on some variety of time symmetry, see introduction). Instead, the present methods described herein apply coarse-graining to a macrostate that provides a map from parameters to observed trajectories that will enable automatic generation of new parameter-trajectory pairs that were not generated by running Eq 7.

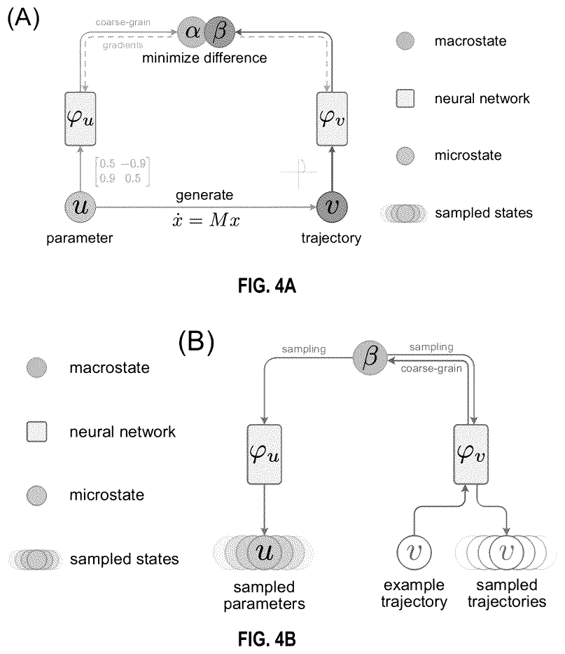

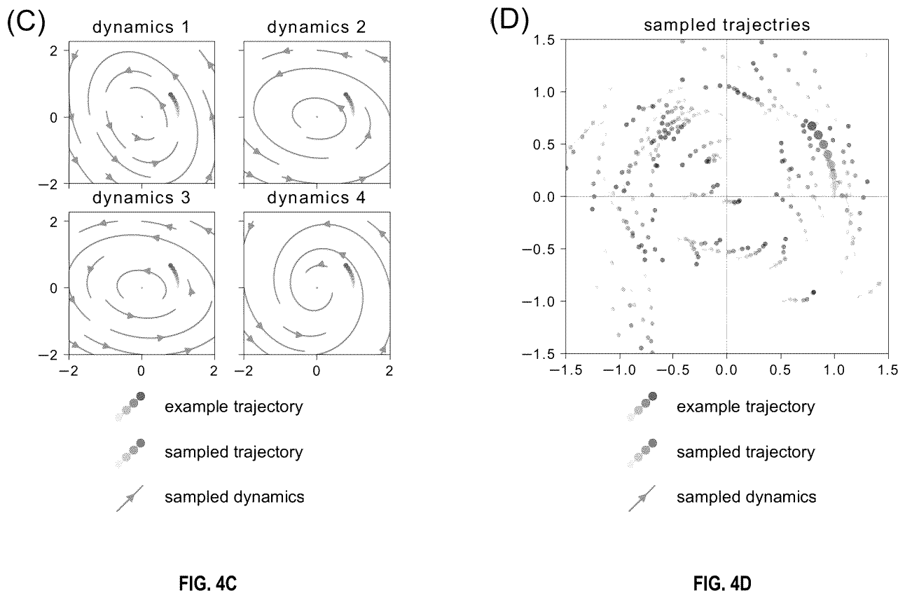

Note that the many-to-many mapping here means: 1) given one parameter, different initial states will lead to different trajectories. 2) sampling different parameters may lead to the same or similar trajectories. Two neural networks are used to learn the macroscale relation between parameters and trajectories: one uses φᵤ to map the 4-d parameter matrix to a 2-d macrostate, and the other uses φᵥ to map the 16-d trajectory to a 2-d macrostate (FIG. 4B), which can be optimized to reduce the mutual information between the identified macrostates in both cases (FIG. 4A).

After training, the learned macrostates can be used to design microstates. In FIG. 4B, given an example trajectory Tₑ, its macrostate can be computed as β=φᵥ(Tₑ). The neural network φᵤ⁻¹ samples parameters that can generate trajectories for the example microstate (FIG. 4C). The sampled parameters follow a conditional distribution P(M|β), where M is the parameter matrix. FIG. 4C shows how, given an anti-clockwise rotating trajectory, the parameters sampled all lead to anti-clockwise trajectories. By this process, parameters of a system can be designed to mimic the behavior of any example, even without needing to translate the language describing the behavior to be human-interpretable. This ability has broad applicability for the design and control of complex systems, where simple mathematical descriptions have defied human scientists. Even when it is unknown or otherwise inaccessible to how a behavior can be described, the neural network can still sample parameters to allow design of new examples through self-supervised learning.

So far, the present disclosure has demonstrated sampling parameters for the matrix M, based on a specified macrostate (rotating anti-clockwise). The present disclosure showed how the sampled parameters allow constructing new example trajectories using the sampled matrix M in Eq 7 with the desired macroscale behavior. Trajectories can also be sampled directly, via a sampling process where the target macrostate is specified and the inverse sampling is used to recover trajectories. These sampled trajectories follow the distribution of P(T|β), where T is the trajectory microstate. FIG. 4D shows that the sampled trajectories all follow the same behavior, exhibiting anti-clockwise rotation, just as with the example trajectory. It is worth noting that implementation of Eq. 7 is not always needed to generate the designed trajectories; the designed trajectories can be sampled directly from identification of the macrostate. The neural network also did not need to receive information about any concept of “rotate” or “clockwise”: the neural network discovered this symmetry on its own, as one that is relevant to how the parameters of the matrix M map to observed trajectories. This experiment gives a simple example of how a neural network architecture like MacroNet can aid in identifying genotype-phenotype maps, where genotypes play the role of parameters and phenotypes the role of trajectories.

### 4.2 Simple Harmonic Oscillators

Although macrostates are defined on identifying symmetries underlying general relations, time relations are still of particular interest because of their long history in physics and their relationship to energy. This section demonstrates how MacroNet can automatically identify the symmetry of time translation invariance associated to energy, using a simple harmonic oscillator (SHO) as a case study. The Hamiltonian of SHOs is:

$$ℋ = \frac{{p}^{2}}{2 m} + \frac{1}{2} k {x}^{2} . \qquad ( 8 )$$

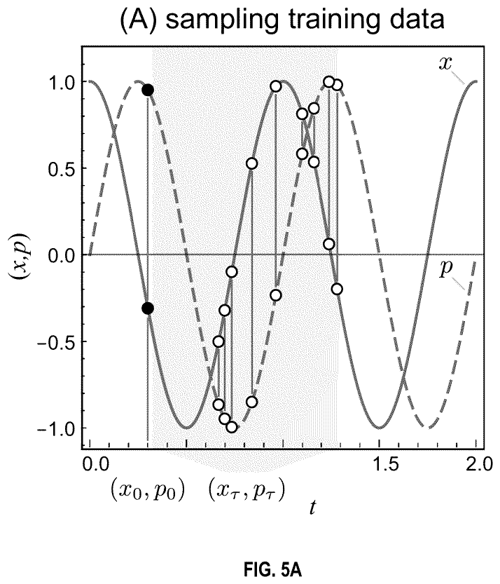

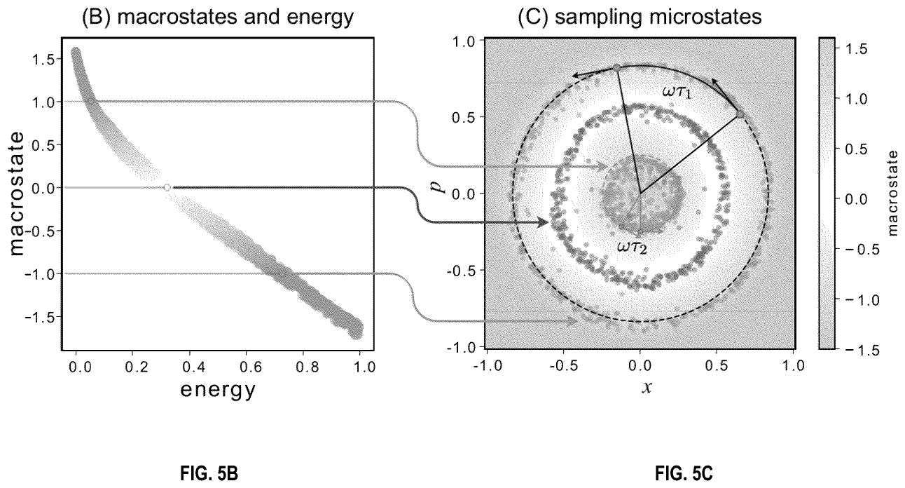

In this experiment, let m=1 and k=1 for all cases. The micro-to-micro relation is a temporal relation, represented by pairs of (xₒ, pₒ) and (x_{τ}, p_{τ}), where x₀ and p₀ are the initial position and momentum and τ is uniformly sampled time interval (0, 2π) (see FIG. 5A). Since the goal is to find a time invariant quantity, the mapping function φᵤ and φᵥ should not be different. So, the two neural networks φᵤ and φᵥ are forced to share the same weights.

FIGS. 5A-5C shows training results. When the neural network is required to learn a one-dimensional invariant as a macrostate, the macrostate is exactly a function of energy (FIG. 5B). FIG. 5C shows samplings from macrostates to microstates. The same color represents microstates sampled from the same macrostate. The sampling shows how the neural network has identified three concentric circles, which correspond to the equal energy surfaces of the SHOs (FIG. 5C), where the equation p²+x²=H represents a circle with a radius of H. Note that the uncertainty of t makes it impossible to accurately predict the future microstates. In fact, the optimal prediction at any microstate will be zero if the MSE loss is optimized. However, MacroNet can still predict the future macrostates and sample microstates from them. This is an example of how predictions at the microscale can fail, and how macrostates can help solving many-to-many mapping problems, such that predictions are still possible.

### 4.3 Turing Patterns

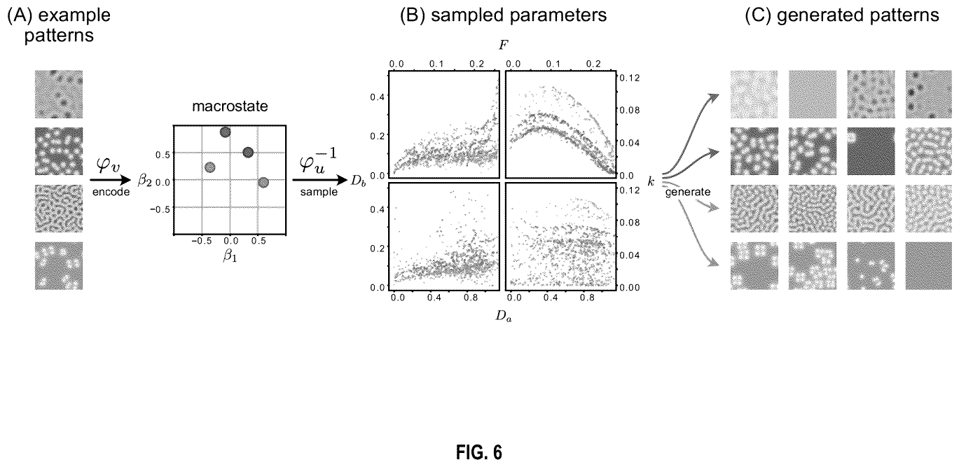

Finally, the same method is applied on a complex system: Turing patterns. Here, the Gray-Scott Model is used which is a 2-d space that has two kinds of components, a and b, which might, for example, correspond to two different kinds of chemical species. The a and b are two scalar fields corresponding to concentration of the two species. Their dynamics can be described by the differential equation:

$$\begin{matrix}\frac{\partial a}{\partial t} = {D}_{a} {∇}^{2} a - a {b}^{2} + F ( 1 - a ) \\ \frac{\partial b}{\partial t} = {D}_{b} {∇}^{2} b - a {b}^{2} - ( F + k ) b\end{matrix} \qquad ( 9 )$$

where Dₐ, D_{b}, F and k are four positive constants—these four parameters determine the behavior of the system. This model can generate a set of complex patterns, see FIG. 6. By finding macrostates mapping patterns to parameters, related systems can then be designed by specifying parameters that will yield user-specified patterns. Here, u is the parameter vector, u=(Dₐ, D_{b}, F, k). And v is the generated pattern, represented by 64×64 images, v=(a^{(64×64)}, b^{(64×64)}).

The neural network is trained to map parameters and patterns to each other at macroscale (such that these will share the same macrostate). FIG. 6 shows the sampling based on the specified patterns. By giving an example pattern v, parameters u′=φᵤ⁻¹(φᵤ(v), z) can be sampled with the same macrostate as v. As FIG. 6 shows, the sampled rules (set of four parameters) will generate similar patterns as the example patterns. This experiment shows that the methods described herein can design complex systems by sampling parameters that will generate patterns exhibiting the same macrostate as the example behavior. That is, MacroNet can solve the inverse problem of going from pattern to parameters.

The microstate ensembles associated with macrostates can also be directly discovered by this approach. The center portion of FIG. 6 shows the distribution of parameters sampled from different macrostates. The sample points with the same color are considered as equivalent to each other under the mapping φ, which takes the microstate to a macrostate. Parameters in the same equivalence class (sharing the same symmetry) will therefore lead to patterns that have the same macrostates, so any parameters along these equivalence curves can be sampled to generate Turing patterns with the user-specified behavior.

An additional feature is that observing the sampled parameters can also be informative of the importance of different parameters for specifying a target macroscale behavior. For example, as shown in the center portion of FIG. 6, different macrostates have similar sampling on Dₐ. However, on (F, k), different macrostates sample different parameters. This indicates that F, k will have stronger effect on differences in macroscale behavior than Dₐ. This has implications for specifying control parameters in designing complex systems. An example of interest is in pattern formation in regeneration, where a framework like MacroNet could identify the patterns controlling specific features of shape.

### 5. Discussion

Since Anderson published the seminal paper, More is Different, it has been increasingly recognized that complex systems displaying emergent behaviors do not necessarily share the same symmetries as their micro-rules. That is, the mapping from a micro-rule to a large-scale system does not preserve all the symmetries of the micro-rule, due to symmetry breaking and perturbations from the environment. In some sense, this is the very definition of “emergence”. However, some symmetries might be retained such that micro-rules share at least a subset of their symmetries with any macroscale emergent behavior. Indeed, this is what is observed in the experiments presented in this disclosure. Each macrovariable can represent a type of symmetry: for instance, the energy of a simple harmonic oscillator represents how all states with the same energy are symmetric in time to others with that energy. In a more complex case, the macrostates of Turing patterns include the information that is invariant under the mapping from parameter to pattern, even under external perturbations. The parameters that have the same macrostate are symmetric to each other because they all generate the patterns with the same macrostate. By finding the macrostates via the mutual information shared between ensembles of microstates, the symmetries shared by the two sets of microvariables can be aligned. This is a general framework for identifying macrostates as maps conserving the symmetries of systems: hence, while given “more is different” is true in most cases, examples of macrovariables that behave as “more is same” can still be found because they will retain underlying symmetries present at the microscale.

The process of finding macrostates can be considered as a prediction problem: that is, it is one of finding predictable variables of two related observations. There are no such variables if two observations have zero mutual information. Thus, if two observations have none-zero mutual information, macrovariables (ensembles of microstates) can be used to connect the two observations. In this way, one can consider macrostates as the instantiated mutual information mapping observations of one system to another (or a system to itself at a different point in time).

Across the experiments, it is shown how macrostates can emerge from identifying predictive relations between two sets of observations. The parameter-trajectory relation leads to the macrostate of rotation and direction. The temporal relation between past and future leads to the macrostate energy in the simple harmonic oscillator. In the more complex case of Turing patterns, macrostates arise from parameter-pattern relationships. Thus, by adopting this relationalism idea, one can establish an approach targeting an ambitious question in the complex systems field: is it possible find general laws of complex systems? To address this question, one key task is to find a set of universal macrostates that can be found in most complex systems. And hence the laws of the universal macrostates can be considered as the general laws of complex systems. The method proposed in this work makes an initial step for this target—by finding macrostates from relations, the macrostates can be used on both sides of the relations (although they may be interpreted differently on either side of the relation). For instance, in the Turing pattern case, the macrostates are not only the macrostates of patterns, but also the macrostates of parameters. For future work, to find more universal macrostates, the framework may be extended from second-order relationship to higher-order relationships. Applying this method more generally to complex systems may reveal there are indeed universal general laws, or it may reveal that no map can apply to all systems—that is, that the laws of complex systems are unique to specific classes of system. In either case, the framework presented herein, which offers an automated means for identifying general laws via symmetries in complex systems, offers new opportunities for asking and answering such questions.

### 6. Further Implementation Details

### 6.1 Definitions and Theory

### 6.1.a Definitions

Equivalence: Two microstates are equivalent if and only if they belong to the same macrostate. Using ˜ to represent equivalence, u˜u′⇔φ(u)=φ(u′). Here φ maps microstates to macrostates.

Relations: The very broad and vague term relation is used to include most types of paired variables. For instance, co-occurrence pairs, data-label pairs, or past-future pairs, etc. For a set of microstate pairs (uᵢ, vᵢ), joint distribution P(u, v) is used to represent all their relations mathematically. Given a microstate uᵢ, its micro-to-micro relation can be defined as a conditional distribution P(v|u=uᵢ) or P(v|uᵢ). Since there are two types of data in the paired datasets, φᵤ(uᵢ) and φᵥ(vᵢ) are used to represent the macrostates of uᵢ and vᵢ respectively. For simplicity, φ is used when there is no ambiguity.

Micro-to-macro relation can be defined as:

$$\begin{matrix}P ( β \vert {u}_{i} ) = {\int }_{v} P ( β \vert v ) P ( v \vert {u}_{i} ) d v \\ P ( α \vert {v}_{i} ) = {\int }_{u} P ( α \vert u ) P ( u \vert {v}_{i} ) du\end{matrix}$$

So, the entire micro-to-macro relations can be represented as P(u, β)=P(u)(β|u) and P(α, v)=P(v)(α|v). Here, P(β|v) is a probabilistic representation of φᵥ, which is a many-to-one mapping since φᵥ is a deterministic mapping. P(v|uᵢ) is a one-to-many mapping because there may exist multiple v pairing with uᵢ.

The macro-to-macro relation can also be represented as the distribution P(α, β).

$${u}_{i} ∼ {u}_{j} ⇔ P r ( β \vert {u}_{i} ) = P r ( β \vert {u}_{j} ) ,$$

$${v}_{i} ∼ {v}_{j} ⇔ P r ( α \vert {v}_{i} ) = P r ( α \vert {v}_{j} ) .$$

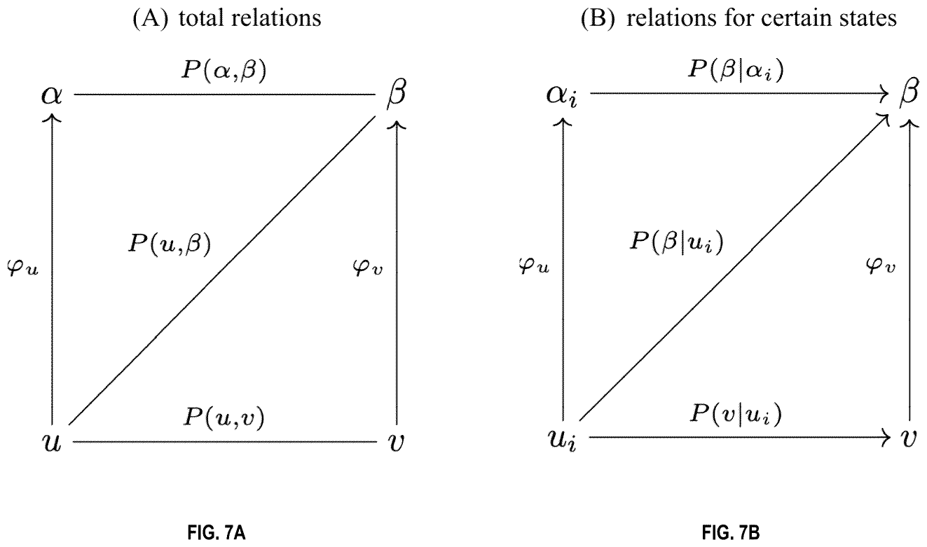

So, macro-to-macro can also be defined for given macrostates as conditional distributions P(β|αᵢ) and P(α, βᵢ). These definitions of relations are illustrated in FIGS. 7A and 7B.

### 6.1.b Definition of Macrostates

Based on the definitions of relations, macrostates can be defined based on micro-to-macro relations.

Definition 1: Macrostate: Two microstates uᵢ and uⱼ belong to the same macrostate if and only if they have the same micro-to-macro relation:

$${u}_{i} ∼ {u}_{j} ⇔ Pr ( β \vert {u}_{i} ) = Pr ( β \vert {u}_{j} ) ,$$

$${v}_{i} ∼ {v}_{j} ⇔ Pr ( α \vert {v}_{i} ) = Pr ( α \vert {v}_{j} ) .$$

The macrostate solutions should be self-consistent. FIG. 1A shows a consistent solution, as an example, u₁˜u₂ because Pr(β|u₁)=Pr(β|u₂) and 01 ˜ 12 because Pr(a|v1) =Pr(a|02). However, FIG. 1B shows an inconsistent solution: The microstates in red circles are all mapped to the orange macrostate in V. So they shouldn't be mapped to different macrostates in U.

Another solution is that all the microstates are mapped to the same macrostate (see FIG. 1C). This kind of solution will not provide any meaningful information about the systems. So, in addition to the definition 1, an information criterion is presented to specify “good macrostates”. That is, given a certain number (or dimension) of macrostates, the information criterion is maximizing the mutual information I(α; β) at the macroscopic level.

### 6.1.c From Definition to Optimization Objective

Since the macrostates in U is defined by the macrostates in V, and macrostates in V are defined by U, it is necessary to optimize φs to find informative and consistent solutions. Based on the definition of macrostates:

$${u}_{i} ∼ {u}_{j} ⇔ Pr ( β \vert {u}_{i} ) = Pr ( β \vert {u}_{j} ) ,$$

$${v}_{i} ∼ {v}_{j} ⇔ Pr ( α \vert {v}_{i} ) = Pr ( α \vert {v}_{j} ) .$$

Continuation can be applied on the definition by introducing distance functions D₁ and D₂:

$${D}_{1} [ {φ}_{u} ( {u}_{i} ) , {φ}_{u} ( {u}_{j} ) ] = {D}_{2} [ Pr ( β \vert {u}_{i} ) , Pr ( β \vert {u}_{j} ) ] ,$$

$${D}_{1} [ {φ}_{υ} ( {υ}_{i} ) , {φ}_{υ} ( {υ}_{j} ) ] = {D}_{2} [ Pr ( α \vert {υ}_{i} ) , Pr ( α \vert {υ}_{j} ) ] .$$

This equation is equivalent to the original version when it is fully satisfied. When choosing D₁ be square Euclidean distance and D₂: be 2-Wasserstein distance, the following formula can be verified as a solution for the macrostate definition:

$${φ}_{u} ( {u}_{i} ) \approx {φ}_{v} ( {v}_{j} ) .$$

More specifically, the solution is:

$${φ}_{u} ( {u}_{i} ) - {φ}_{v} ( {v}_{i} ) ∼ N ( 0 , \sum ) ,$$

where (uᵢ, vᵢ) is sampled from P(u, v), and tr(Σ)<<1. Using P(α|uᵢ) and P(β|vᵢ) to represent φᵤ(uᵢ) and φᵥ(vᵢ) as distributions:

$$\begin{matrix}Pr ( β \vert {u}_{i} ) = {\int }_{v} P ( β \vert v ) P ( v \vert {u}_{i} ) dv \\ = {\int }_{v} P ( α + δ \vert {u}_{i} ) P ( v \vert {u}_{i} ) dv \\ = P ( α + δ \vert {u}_{i} )\end{matrix}$$

where δ˜N(0, Σ) and tr(Σ)<<1. Here P(β|u) was replaced with P(a+δ|uᵢ) because φᵤ(uᵢ)≈φᵥ(vᵢ). So, Pr(β|uᵢ) and Pr(α|vᵢ) are both normal distributions with low standard deviations. For normal distributions X and Y, the 2-Wasserstein distance has a simple form:

$${{W}_{2} ( X , Y )}^{2} = {\vert {μ}_{x} - {μ}_{y} \vert}^{2} + tr ( {\sum }_{x} + {\sum }_{y} - 2 {( {\sum }_{x} {\sum }_{y} )}^{1 / 2} ) ,$$

So, the definition becomes:

$${\vert {φ}_{x} ( {u}_{i} ) - {φ}_{x} ( {u}_{j} ) \vert}^{2} = {\vert E ( {φ}_{v} ( {v}_{i} ) - {φ}_{v} ( {v}_{j} ) ) \vert}^{2} + tr ( {\sum }_{i} + {\sum }_{j} - 2 {( {\sum }_{i} {\sum }_{j} )}^{1 / 2} ) ,$$

$${\vert {φ}_{υ} ( {υ}_{i} ) - {φ}_{υ} ( {υ}_{j} ) \vert}^{2} = {\vert E ( {φ}_{u} ( {u}_{i} ) - {φ}_{u} ( {v}_{j} ) ) \vert}^{2} + tr ( {\sum }_{i}^{′} + {\sum }_{j}^{′} - 2 {( {\sum }_{i}^{′} {\sum }_{j}^{′} )}^{1 / 2} ) ,$$

Since Σ>>1, the trace term can be abandoned and the expectations can be removed:

$${\vert {φ}_{u} ( {u}_{i} ) - {φ}_{u} ( {u}_{j} ) \vert}^{2} \approx {\vert {φ}_{v} ( {v}_{i} ) - {φ}_{v} ( {v}_{j} ) \vert}^{2} ,$$

$${\vert {φ}_{v} ( {v}_{i} ) - {φ}_{v} ( {v}_{j} ) \vert}^{2} \approx {\vert {φ}_{u} ( {u}_{i} ) - {φ}_{u} ( {u}_{j} ) \vert}^{2}$$

The formulas still hold when substitute φᵤ(uᵢ)≈φᵥ(vⱼ) into it. So, φᵤ(uᵢ)≈φᵥ(vⱼ) is a verified solution for the definition. This solution can be approximated by minimizing the distance between φᵤ(uᵢ) and φᵥ(vᵢ). There may exist other more general but more complex solutions. However, this simple approach shows good performance in experiments.

### 6.2. Developing Methods

### 6.2.a Invertibility and Distribution Control

Technically, the framework requires two key features of the neural network that approaching φ: conditional sampling, and controlling distribution of their outputs. Luckily, the invertible neural networks (INNs) cover both features. The invertibility makes conditional sampling possible. And the distribution control feature makes it possible to avoid trivial solutions without a large number of negative samples (65536 negative samples are used).

In a broad definition, the INNs can be classified into two types: flow-based models, and models that are trained to be invertible such as InfoGAN. The flow-based model, including the coupling models such as RealNVP, NICE, and ResNet-based models such as invertible residual networks and ResFlow. All of these models have two common designs: first, they are guaranteed to be invertible, no matter how well they have been trained. Second, they are easy to compute determinants of Jacobians.

With the information of determinants of Jacobians, the output distribution can be controlled by the “change of variable” theorem. Here, for simplicity, let's just consider an extreme case: if a linear matrix that maps a three-dimensional manifold to a zero, one, or two-dimensional manifold that is embedded in three-dimensional space. Then, the rank of the matrix must be two or lower. Hence, the determinant of Jacobian will be zero. So, by avoiding having zero determinants of Jacobians, the dimension collapse can be avoided, hence avoiding trivial solutions.

Another type of INNs is the models that are trained to be invertible. Such models should also have the two features as flow-based models: invertibility, and distribution control. InfoGAN architecture is an example that follows the requirements. Compared to villina GANs, the InfoGAN is simply doing two different things: 1) splitting the input noise into two parts c and z. 2) add a Q network that can reconstruct the c information, i.e., Q[G(c, z)]→c, where G is the generator. The inverse of InfoGAN is trained, it can partially inverse the process of G: (c, z)→x by using Q: x→c, while the z information is lost. This loss will not affect the macrostate framework, because micro can be mapped to macro by Q: u→α, and sample macro to micro by G: (α, z)→u. The ability of distribution control is achieved by the reconstruction process and discriminator together. Given that discriminator exists, if c is sampled from a distribution P and z˜N(0, 1), then G(c, z) will follow the data distribution. Since Q is trained to predict c by the generated samples, as an inverse process, Q (x˜P_{data}) will follow the distribution of P. By controlling the distribution, InfoGAN can also avoid trivial solutions.

The experiments have all been trained on flow-based models. This choice is made for three reasons: 1) flow-based models are guaranteed to be invertible. and 2) flow-based models are not likely to have mode collapse problems, while GAN based models often have such problems. This is critical in order to design microstates. 3) flow-based models make the experiments more concise. However, the InfoGAN structure can still be useful when a high expressivity is needed because it can use more different neural network structures.

To make INNs easy to use, a python package INNLab was developed, including three types of INNs: RealNVP, NICE, and ResFlow.

### 6.2.b Invertible Neural Networks

Table 1 compares different types of INNs. The forward and inverse column shows the mapping from input x to output y, and y to x.

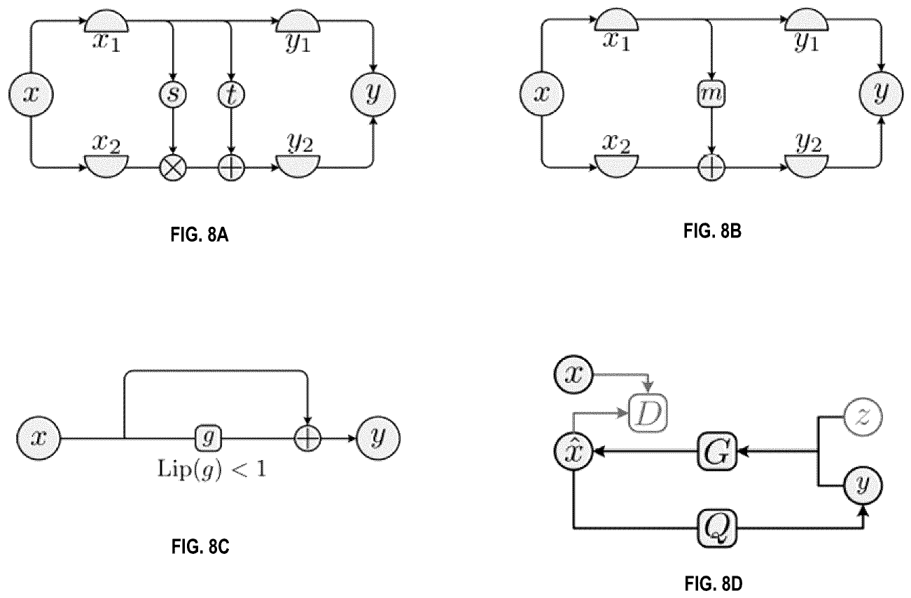

TABLE 1

| name | structure | forward | inverse |
|---|---|---|---|
| Real NVP | FIG. 8A | y₁ = x₁ | x₁ = y₁ |
| | | y₂ = x₂s(x₁) + t(x₁) | X₂ = (y₂ − t(x₁))/s(x₁) |
| NICE | FIG. 8B | y₁ = x₁ | x₁ = y₁ |
| | | y₂ = X₂ + t(x₁) | X₂ = y₂ + t(y₁) |
| | | | $x = {lim}_{n \to inf} {x}_{n}$ |
| ResFlow | FIG. 8C | y = x + g(x) | xₙ = y − g(xₙ − 1), |
| | | | If Lip(g) < 1 |
| InfoGAN | FIG. 8D | y = Q(\hat{x}) | \hat{x} ~ G(y, z), |
| | | | Where z is a noise input. |
| | | | InfoGAN cannot do an |
| | | | exact inverse because it |
| | | | is trained to be invertible. |

illustrations for multiple versions of invertible neural networks (INNs).

### 6.3.c Coarse-Graining and Sampling

The flow-based models require the output and input to have the same dimensions for invertibility. So, in order to coarse-grain and upsampling, a special way to change dimensions should be adopted.

A multi-scale architecture was used which let the network abandon dimensions: f: x→(y,z), where z is the abandoned dimensions, and y can be used to do supervised or self-supervised training. In this way, the dimension can be reduced and coarse-graining can be applied. In the forward process, given a N-dimensional input, the output will be splitted into two variables α^{(D)} and z^{(N-D)}, where superscripts show their dimensions. Only a will be trained to satisfy φᵤ(uᵢ)=φᵥ(vᵢ). To make it clear, o can represent the mapping from u to α, and use Φ to represent the mapping from u to (a, z).

However, z is not totally ignored. Since it is also an object to apply conditional sampling, the distribution of z should also be trained to be an independent normal distribution. So, the Jacobian of φ is computed by Φ so z can be included. When applying conditional sampling, given the macrostate α^{(D)} or β^{(D)} a z^{(N-D)} is sampled to compute Φ⁻¹(α,z). The coarse-graining and sampling process are summarized in Table 2.

TABLE 2
details of coarse-graining and sampling process.

| | forward | training |
|---|---|---|
| coarse-graining | Φ(u^{(N)}) = (α^{(D)}, z^{(N-D)}), | both α and z will be |
| | Where z^{(N-D)} is the abandoned | trained to follow |
| | dimensions. And φ(u) = α. | independent normal |
| | | distribution. z will not be |
| | | stored since its |
| | | distribution is known after |
| | | training. And α will be |
| | | trained as a microstate. |
| sampling | φ⁻¹(α) = Φ⁻¹ (α^{(D)}, z^{(N-D)}) = u^{(N)}, | — |
| | where Z^{(N-D)} is sampled from an | |
| | independent normal distribution | |

Since (α, z) is trained to be independent normal distributions, the P(z|α) should also follow normal distribution. With this feature, conditional sampling of u can be applied from P(u|φ(u)=a).

### 6.3 Experiments

### 6.3.a Training Tricks

The flow-based models have limitations of expressivity since their Jacobian and dimensions are restricted. A common way to overcome this problem is to have more layers of INNs, for example, the Glow model uses nearly one hundred layers to do generative tasks on the CIFAR10 dataset. However, for some tasks which have very low dimensions, more layers cannot provide results that are good enough. To solve this problem, two useful tricks are applied for different situations.

(1) Noisy Kernel trick. The expressivity problem can often be overcome by adding more layers of INNs. However, the experiments show that when the input dimension is too low, adding layers will not help. While extending neural networks wider can significantly improve the performance. To extend the neural network of INN, it is necessary to extend the input dimension:

$${u}^{′} = [ u , x ] ,$$

$$x ∼ {N}^{d} ( 0 , 1 ) .$$

With this method, d dimensions can be added to the inputs. Here, the u is the original input, and x is the appended input, which is sampled from a normal distribution. Note that x has to be sampled from a d-dimensional distribution instead of zeros. This is because the flow-based model will be trained to map inputs to an independent normal distribution. However, if inputs are appended by zeros, the input itself will be a lower dimensional manifold, which makes it impossible to be mapped to an independent normal distribution and leads to unstable training.

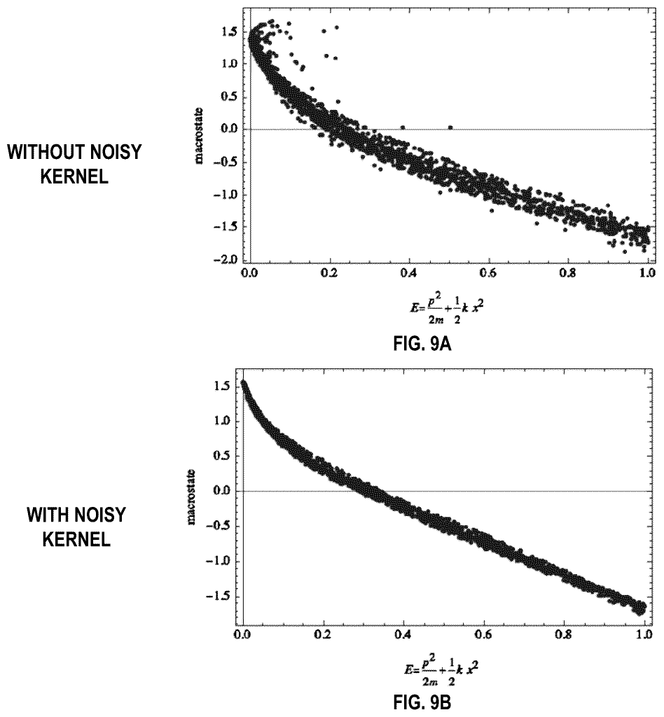

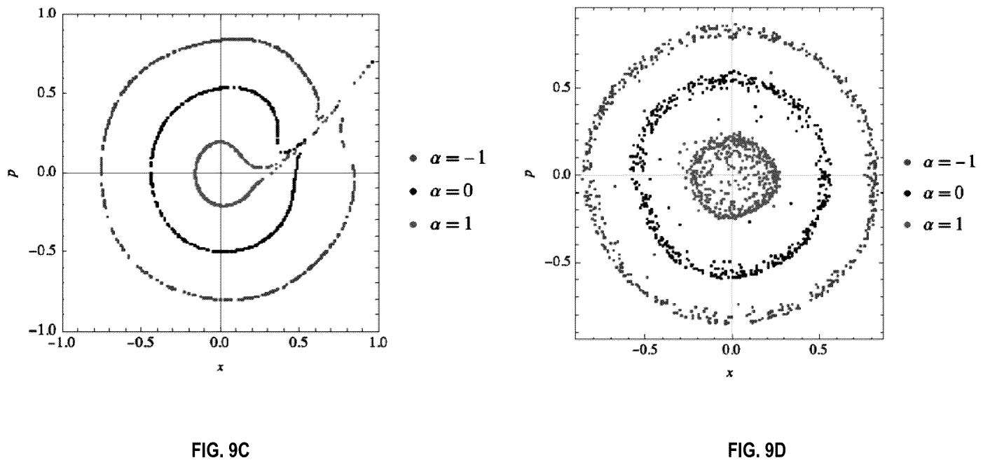

Recall the coarse-graining process: φᵤ: u→α. Here the α is a lower dimensional vector compared to u. When u is replaced by u′, the additional dimensions will increase the expressivity of flow-based models, which will lead to better performance. FIGS. 9A-9D show that noisy kernels can significantly improve the performance.

However, the added noise will also have side effects on sampling. The additional dimensions in z will add noise to the output when doing sampling (see FIGS. 9A-9D). So, noisy kernels can be used when necessary, for example, when the dimension is too low.

(2) One-side INN structures. In many cases, only one side of microstates needs to be sampled. In such a case, it is only necessary to let one of two networks (i.e., φᵤ or φᵥ) be invertible. The other network can have a free form. This simplifies the training process since the free-form neural networks will have higher expressivity. This method is adopted for finding macrostates of Turing patterns.

(3) Putting batch normalization at the last layer. The common practice in neural networks often puts the linear layer as the last layer. In MacroNet, although the distribution term is present to avoid trivial solutions, putting the batch normalization layer as the last layer (or before the last resize layer) will further improve the performance. This is because there is a potential tradeoff between the prediction loss and the distribution loss, which may bias the distribution of macrostates. This trick cannot omit the importance of the distribution loss. Given the macrostates having standard deviation be one, the outputs can still be low dimensional manifolds which lack information.

### 6.3.b Linear Dynamical Systems

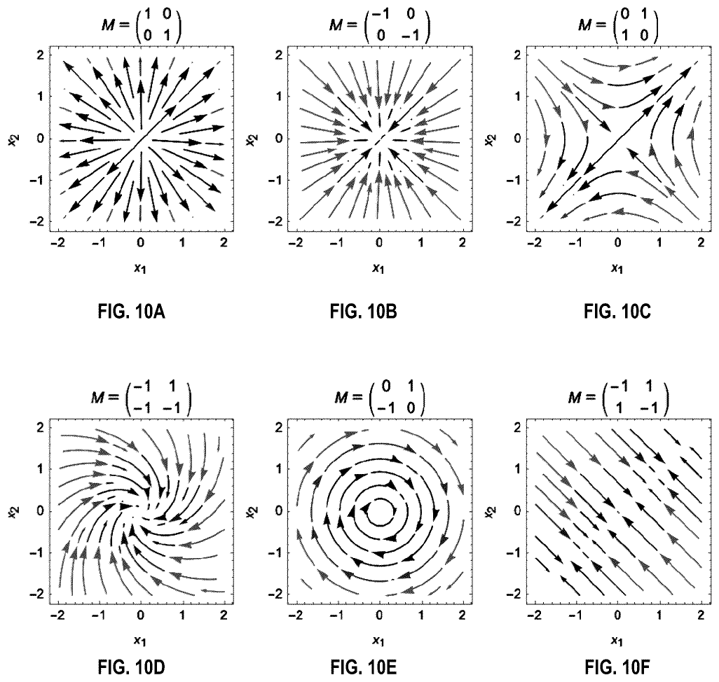

A linear dynamical system can be represented as a differential equation:

$$\frac{d \vec{x}}{dt} = M \vec{x}$$

where M is a n×n matrix. n is the dimension of vector \vec{x}. So, when the system has different \vec{x} the d\vec{x}/dt will be different. This will lead the trajectories to have different behaviors, such as attractor, limit cycles, rotations or saddles (see FIGS. 10A-10F).

So, there exist many-to-many mappings between the matrix and trajectory:
1. one-to-many: For the same matrix M, depending on initial states, the trajectories can be different. For instance, given M=I, the trajectories can move to the right or left if the initial state x₀=(1, 0) or (−1, 0).
2. many-to-one: Also, even with different matrices, the trajectories can be the same when the initial state is properly chosen. For instance, when M₁=I, and M₂ be a permutation matrix that permutes between dimension 1 and 2, their trajectories can be the same when the initial state x₀=(ξ, ξ), where ξ>0.

For such many-to-many mapping situations, the macro state theory and machine learning method can help design the matrix for given trajectories. Here the macrostates are defined on the relation of the 2×2 parameter M and the trajectory [x₁, x₂, . . . , xₙ₋₁], where n=8. Coarse-graining is applied on both sides to a 2-dimensional space as the macrostate. FIG. 4A discussed above shows the training process of finding macrostates from linear dynamical systems in which both the parameters and trajectories are coarse-grained to 2-dimensional macrostates.

The training data is generated by an algorithm. For each (u=M, v=x_{0:n-1}) pair, the M is firstly sampled from an independent normal distribution N(μ=0,σ=1). And the initial state x₀ are sampled uniformly and independently in a 2-dimensional space U²(−1, 1).

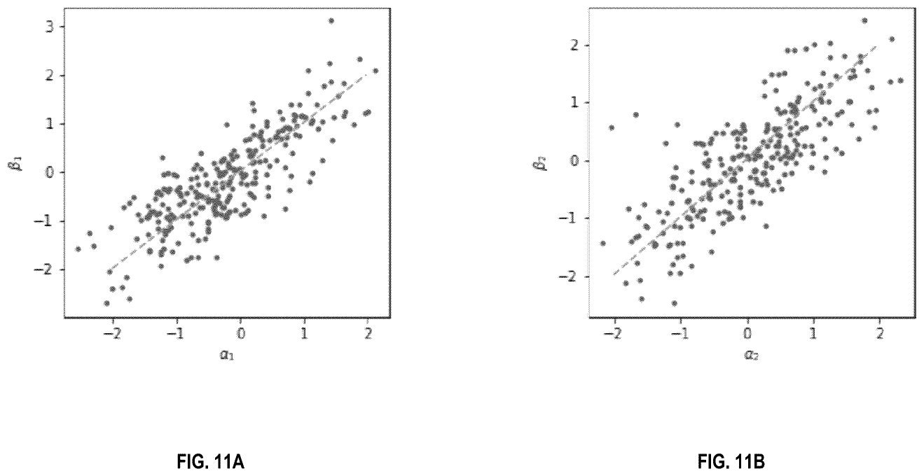

The training takes 2000 epochs, and each epoch has 512 samples with a batch size of 256. Adam optimizer is used to train the model. The learning rate is 10⁻³ and the weight decay is 10^{-5.} Let γ=0.1 to balance the invariant loss and distribution loss. FIGS. 11A and 11B show the scatter plot of macrostates (α, β), which indicates the accuracy of prediction at macrostates.

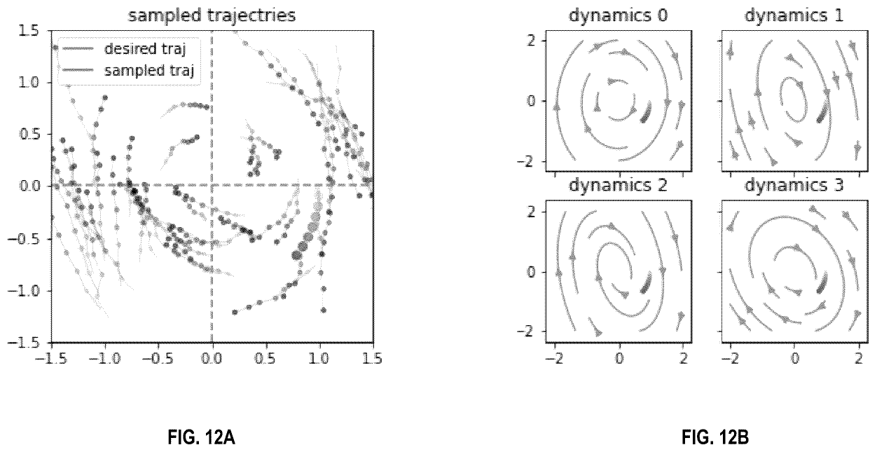

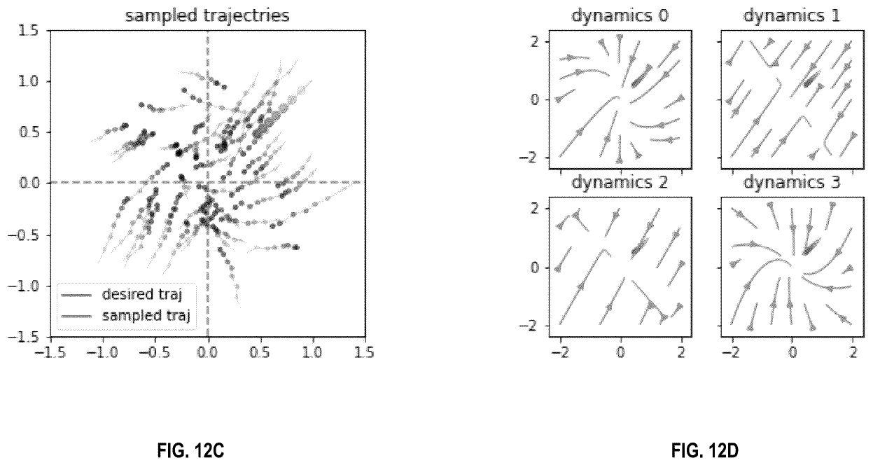

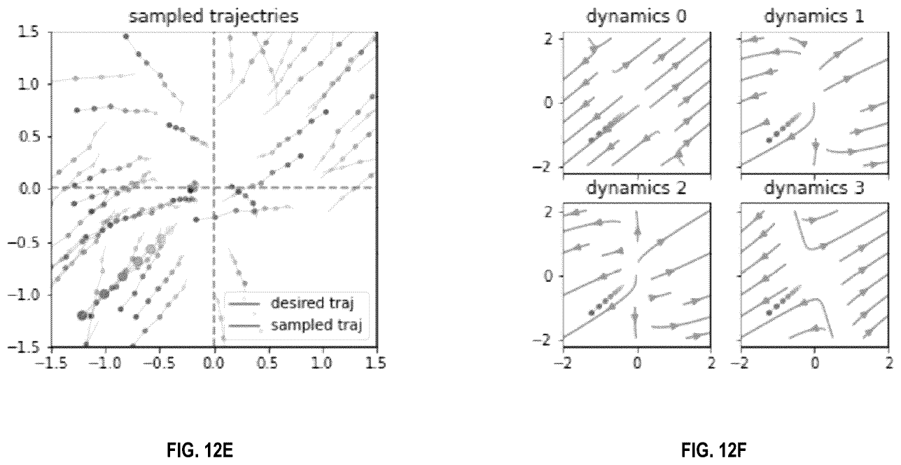

After training, two things can be applied: given a trajectory sₑ as “example behavior”, use φᵥ to sample other trajectories that have the same macrostate as sₑ. Or, given a trajectory, use φᵤ to sample parameters that can generate this trajectory with certain initial states. The sampling with different desired behaviors are shown in FIGS. 12A-12F.

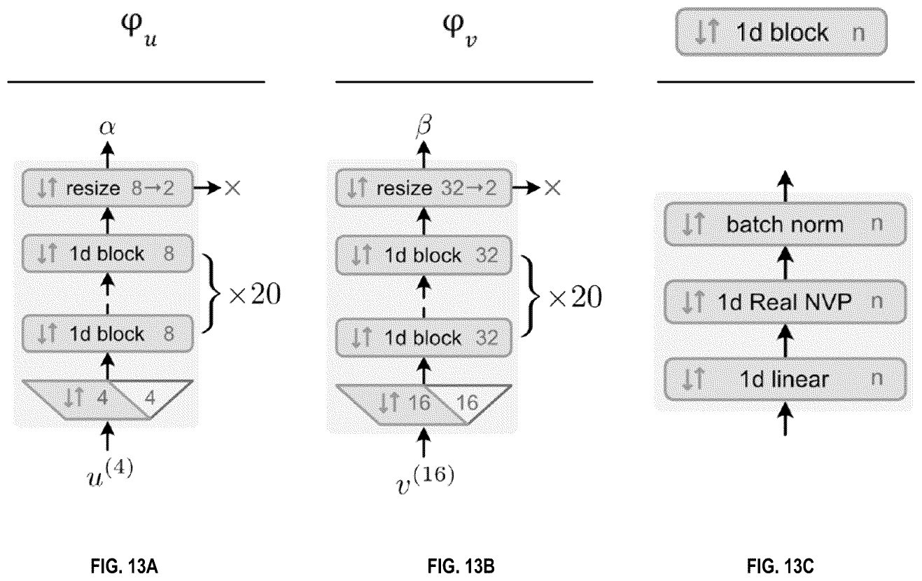

Neural network architecture: The neural network maps the parameters and trajectories to a two-dimensional space as the macrostates. To improve the performance, noisy kernels are used to improve the performance. For the u-side (parameter side), noisy kernel is used to increase the dimension from 4 to 8. For the v-side (trajectory side), noisy kernel is used to increase the dimension from 16 to 32. The noises are independently sampled from (0, 10⁻³). The details of the structure of the neural networks are in FIGS. 13A-13C.

In FIGS. 13A-13C noisy kernels are adopted, represented by trapezoids. For φᵤ, the 4-dimensional microstates input are increased to 8 dimensions by the noisy kernels. After that, there are 20 1-dimensional INN blocks. At the end, 6 dimensions are abandoned to get a 2-dimensional output. The 1-dimensional INN block is composed of a linear INN, a RealNVP 1-dimensional layer, and an invertible batch normalization layer.

### 6.3.c Simple Harmonic Oscillator

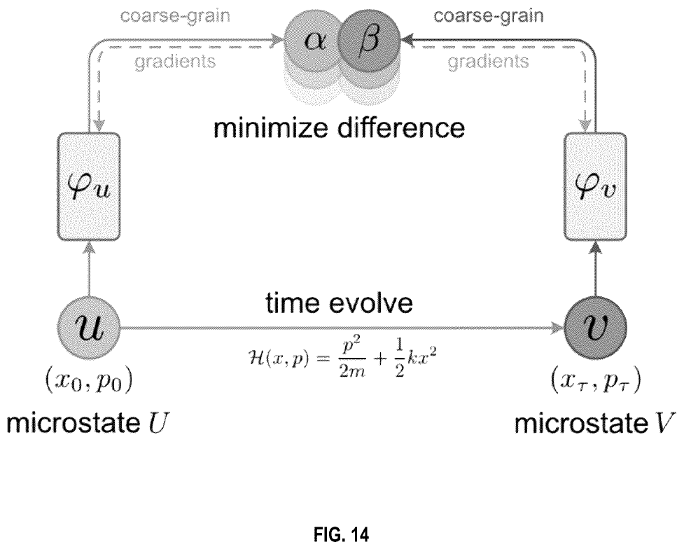

There is an important special case of the macrostates. When the relation is built on temporally connected microstates, the neural network is predicting future macrostates, which is similar to the contrastive predictive learning, but adding the conditional sampling ability. Furthermore, if the two neural networks are forced to share the same parameter, then it is learning time invariant quantities. Here simple harmonic oscillators (SHOs) are used as an example. The Hamiltonian of SHOs is:

$$H ( x , p ) = \frac{{p}^{2}}{2 m} + \frac{1}{2} {kx}^{2} ,$$

where p=mv is the momentum, x is the position, m is the mass, and k represents the elasticity of the spring. In this experiment, let m=1 and k=1 for all cases. So, the solution is:

$${x}_{t} = A cos ( t + ϕ ) ,$$

$${p}_{t} = - A sin ( t + ϕ ) ,$$

where A depends on the initial energy, A=\sqrt{x₀²+p₀²}. And ϕ is the initial phase, ϕ=arctan (p₀/x₀). The microstate of simple harmonic oscillator is (xₜ, pₜ). To find an invariant quantity, the macrostate of u=(x₀, p₀) should be as close as the macrostate of v=(x_{τ}, p_{τ}), where τ follows the uniform distribution U(0, 2π). So, since τ is a random variable, predicting (x_{τ}, p_{τ}) is not possible. However, the macrostate can be predictable. The training architecture is shown in FIG. 14.

2048 samples of (u, v) pairs are used to train the neural network. The training takes 200 epochs with a batch size of 256. Adam optimizer is used to optimize the neural network. The learning rate is 5×10⁻³. The learning rate decreases by 0.1 in each 60 epochs. To balance the invariant loss and distribution loss, γ=0.5.

FIGS. 5B and 5C discussed above show the invariant found by the neural network has a clear and monotonous relation to the energy. The microstates (x, p) can also be sampled from given invariant by implement φ⁻¹(α). The results show that the neural network can sample a ring in (x, p) space, which is exactly the solution of p²+x²=H.

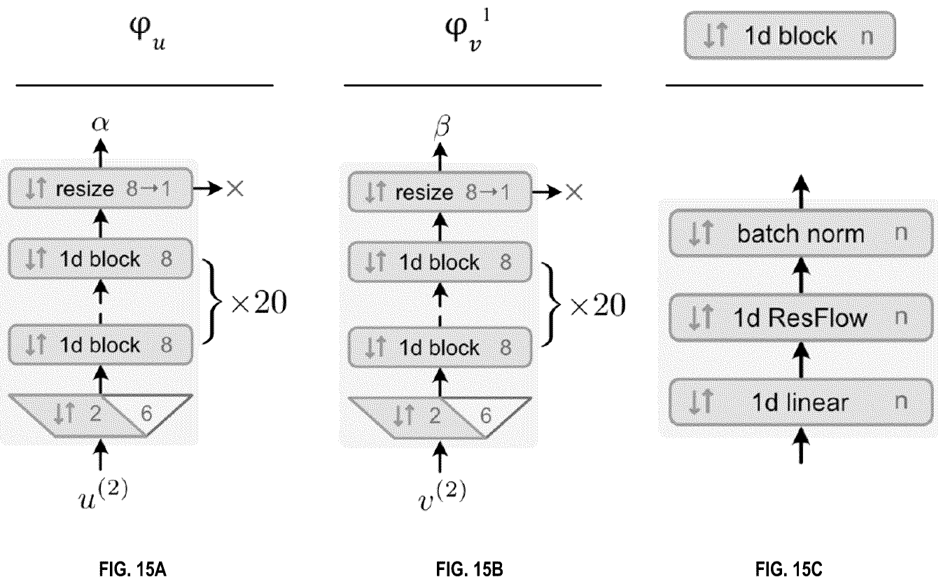

Neural network architecture: Since the dimension of the microstate is two, a noisy kernel is used to increase it to eight dimensions. The noise follows the distribution of N⁶(0, 10⁻¹). Residual flow is also used as the basic block to increase the expressivity. The details of the neural network are shown in FIGS. 15A-15C. Note that here, φᵥ shares the same weight as φᵤ.

FIGS. 15A-15C show the neural network structure for finding macrostates of simple harmonic oscillators. To find invariant quantity, the φᵤ and φᵥ have the same structure and share the same weight. The RealNVP layer was replaced with the ResFlow layer to get better performance, while it takes longer time to be trained.

### 6.3.d Turing Patterns

The Turing patterns are two-dimensional patterns generated by reaction-diffusion models. By changing the parameter of the model, the reaction-diffusion model can generate many different types of patterns. In this experiment, macrostate theory is used to find the macrostate of the patterns and parameters. Then, parameters are sampled that can generate certain types of patterns.

Here the Gray-Scott model is used as the reaction-diffusion model. In this model, there are two types of chemical components, their densities are represented as a and b. The dynamics are represented by the following differential equations:

$$\frac{\partial a}{\partial t} = {D}_{a} {∇}^{2} a - {ab}^{2} + F ( 1 - a ) ,$$

$$\frac{\partial b}{\partial t} = {D}_{b} {∇}^{2} b + {ab}^{2} - ( F + k ) b ,$$

where Dₐ, D_{b}, F and k are four positive parameters that determine the behavior of the system. So, a microstate u here is a vector of the four parameters, i.e., u=(Dₐ, D_{b}, F, k). And the microstate v is the pattern generated by the parameter, while the initial pattern is sampled from a random distribution. The differential equation is approximated on a 2×64×64 tensor by using Euler method with step size dt=0.1.

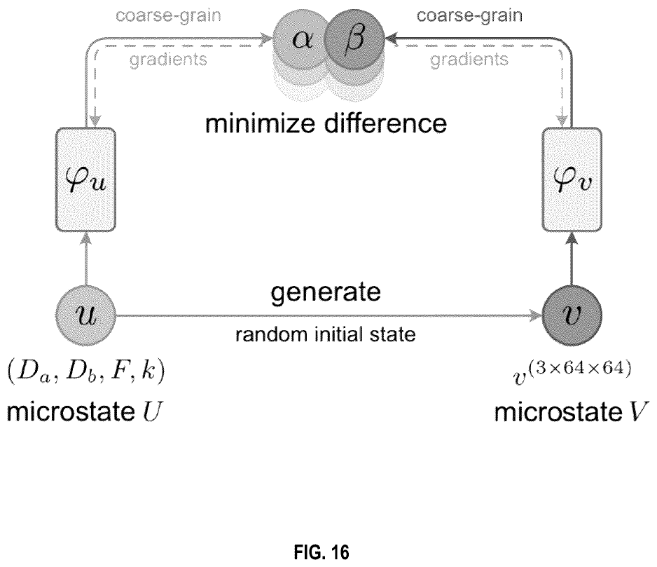

The (u, v) pairs are sampled by selecting the pairs that have non-trivial v. Which means cases were omitted in which v only include the same value. Using this method, 1024 pairs of microstates are sampled. The training architecture is shown in FIG. 16 for finding macrostates from Turing patterns. The neural networks maps the parameter (Dₐ, D_{b}, F, k) and patterns v^{(3×64×64)} to macrostates in a two-dimensional space.

The neural network is trained for 1000 epochs with Adam optimizer. The learning rate is 10⁻³. To help the training converge, the learning rate is reduced by 0.5 every 128 epochs. To balance the prediction loss and distribution loss, let γ=0.1.

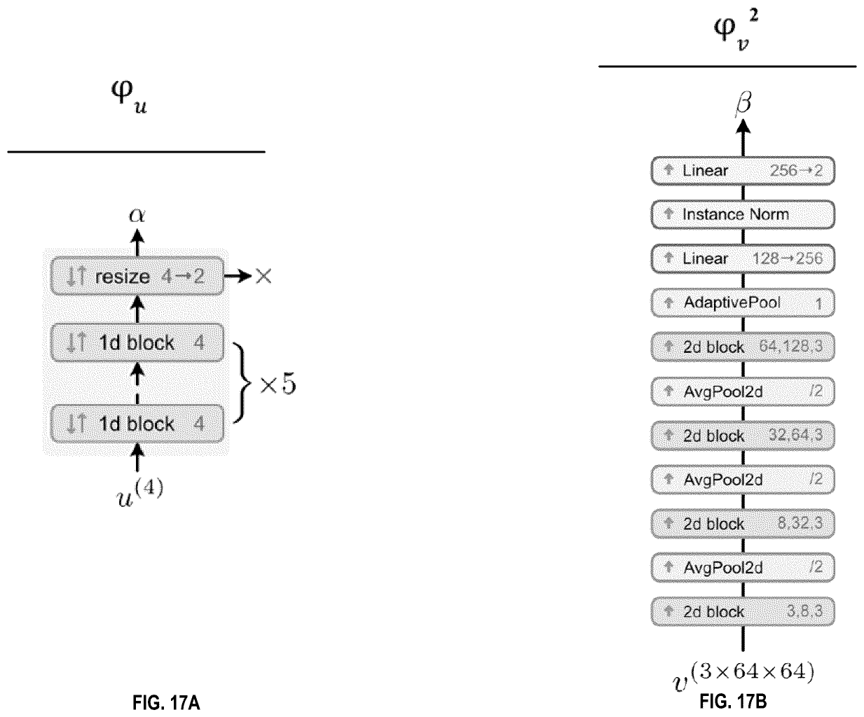

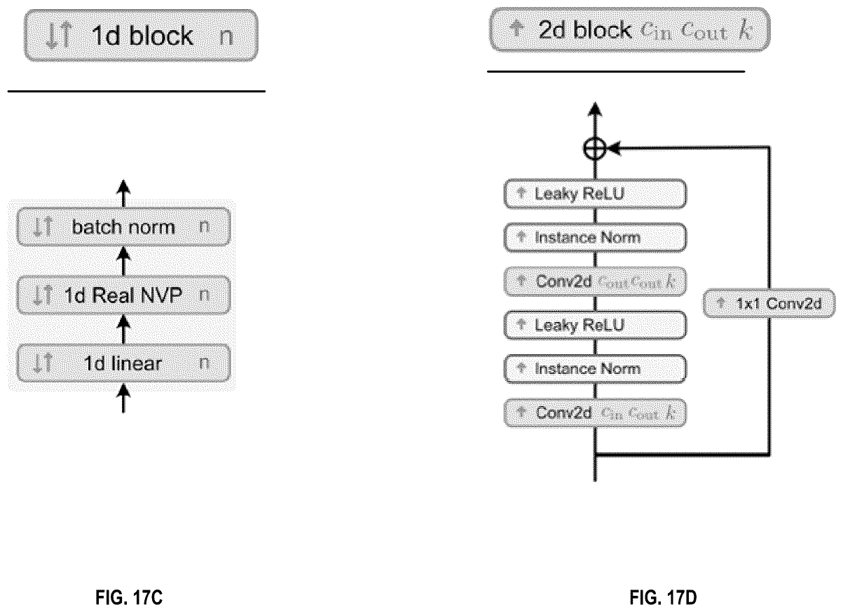

Since it is not necessarily an object to sample the pattern v, let φᵤ be invertible, and let φᵥ be a free form neural network. This will make φᵥ have higher expressivity and easier to train. The φᵤ uses 5 invertible blocks and one resize block to reduce the dimension from 4 to 2. Each invertible block includes an invertible linear layer, a Real-NVP layer, and a batch normalization layer. The φᵥ is a convolutional neural network that maps 3×64×64 tensor to a two dimensional vector. Note that the channel is changed from 2 to 3 by the mapping (a, b)→(a, b, (a+b)/2) to make it have better visualization and easier to do data augmentations, while not losing or altering any information. The detailed neural network structure for finding macrostates of Turing patterns is shown in FIGS. 17A-17D. For the parameter side (φᵤ) a 5-layer INN is used to get a 2-dimensional output. For the pattern side (φᵥ), since generation is not needed, a free-form neural network is used to get a 2-dimensional output.

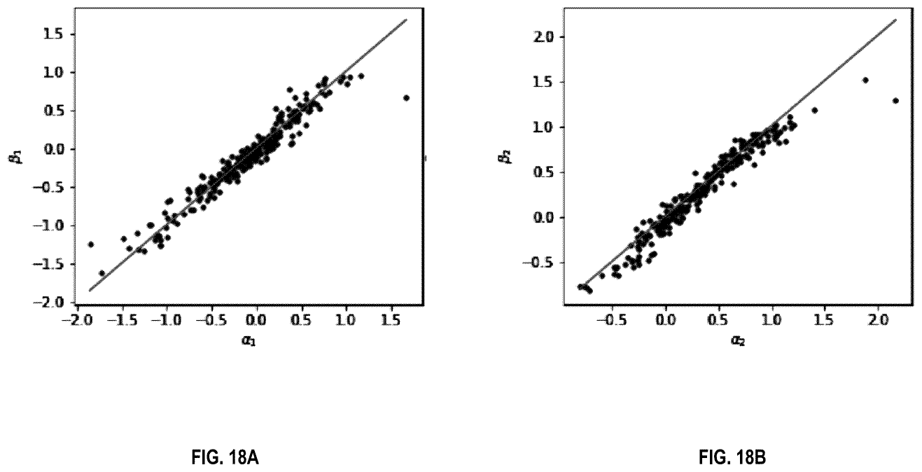

FIGS. 18A and 18B compare the macrostates mapped from parameters (α) and macrostates mapped from patterns (β). Most points are laying on the α=β line, which indicates that this trained neural network made good prediction at macro-level. The trained neural network is capable of predicting the macrostate. Here, each point represents a (u, v) pair. Here, α=φᵤ(u) and β=φᵥ(v). Here, the microstates are mapped to a two-dimensional space, so the macrostates on each dimension, represented as α and β.

6.3.e. 2-dimensional Cellular Automata

The methods outlined herein are also explored on discrete systems such as the 2-dimensional totalistic cellular automata. A totalistic cellular automata is a grid system in which each binary node (cell) v_{i,j}, is updated by the following rule simultaneously:

$${v}_{i , j}^{( t + 1 )} = f ( {\sum }_{dx = - 1}^{1} {\sum }_{dy = - 1}^{1} {v}_{i + dx , j + dy}^{( t )} )$$

So, for f, where exists 10 different inputs (0˜9), hence there are 2¹⁰⁻¹=512 different rules. A number can be assigned to f as the rule number. For simplification, rule N is used to represent a certain rule.

In the experiments, the (u, v) pairs are rules and generated patterns. Each vᵢ is sampled by evolving rule uᵢ with a random initial state, in which each cell is sampled from a Bernoulli distribution. The rule uᵢ is represented as a length-10 binary code.

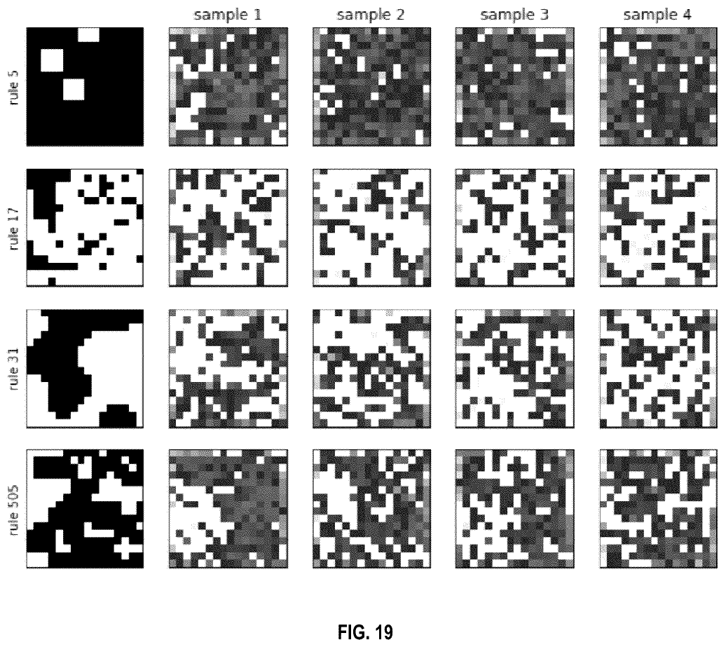

Here φᵤ and φᵥ are both INNs, so both patterns and rules can be sampled. FIG. 19 shows the sampling of patterns. Four example patterns are sampled from 2-d totalistic cellular automata with rule 5, 17, 31, 505. The results show that the macrostates can learn the density of patterns as macrostates.

With reference to FIG. 19, given a desired pattern v′ (black-white patterns), patterns can be sampled with same macrostates (blue-white patterns) by implementing the inverse function φᵥ⁻¹(φᵥ(v′), z), where z is sampled from a multi-dimensional independent normal distribution.

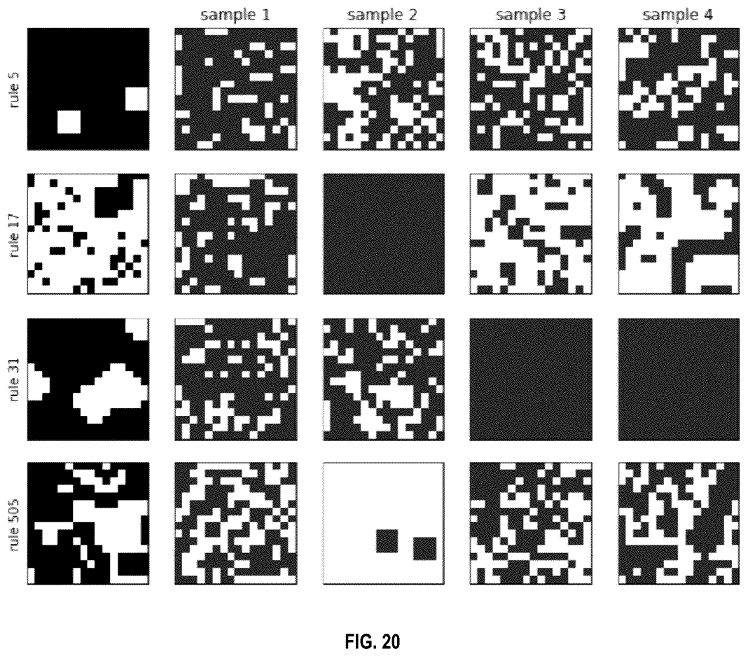

However, when sampling rules from desired patterns, the sampled rules do not share similar behavior as the desired patterns (FIG. 20). This shows a limitation of MacroNet: when the relationship between u and v is highly sensitive, the sampling may fail. In the cellular automata case, one bit change in rule may cause a huge difference in the generated patterns. Since the invertible neural networks lack expressivity, it may not be able to capture such complex relationships. However, this problem may be resolved by replacing the φ by the InfoGAN structure since it allows free-form neural networks.

With reference to FIG. 20, given a desired pattern v′ (black-white patterns), rules with same macrostates can be sampled by implementing the inverse function φᵤ⁻¹(φᵥ(v′), z), where z is sampled from a multi-dimensional independent normal distribution. The blue-white patterns on the right are generated by the sampled rules with random initialization.

### 7. Computer-Implemented System

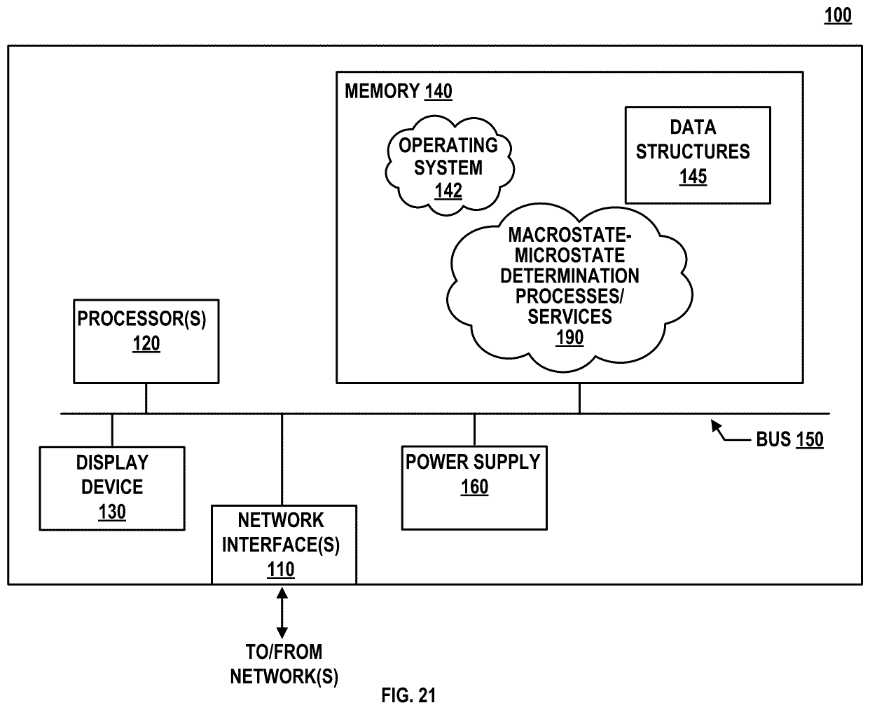

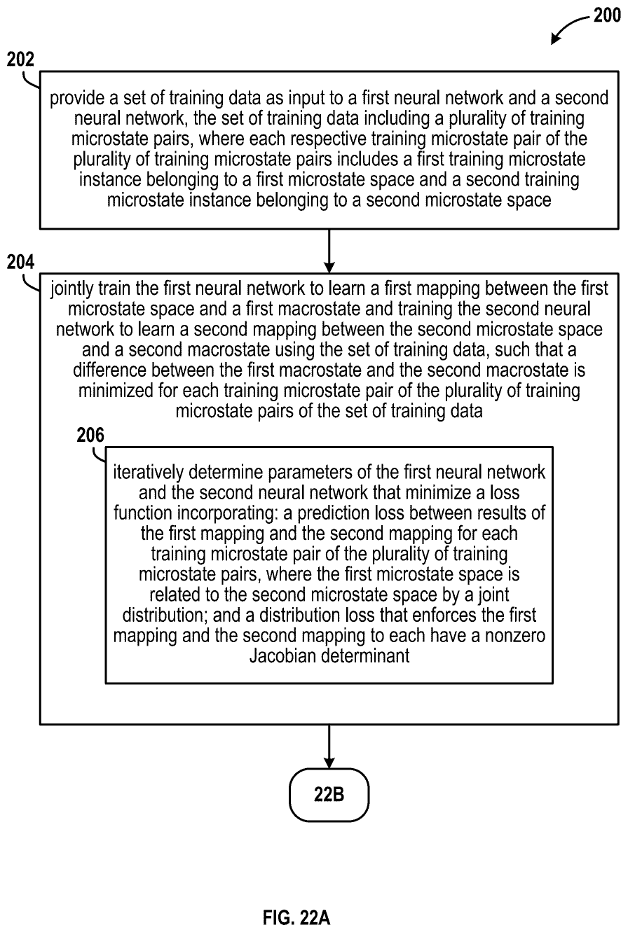

FIG. 21 is a schematic block diagram of an example device 100 that may be used with one or more embodiments described herein.

Device 100 comprises one or more network interfaces 110 (e.g., wired, wireless, PLC, etc.), at least one processor 120, and a memory 140 interconnected by a system bus 150, as well as a power supply 160 (e.g., battery, plug-in, etc.). Further, device 100 can include a display device 130 that displays results of the methods outlined herein, which can be in the form of graphical representations similar to those shown in FIGS. 4C, 4D, 5B, 5C, 9A-9D, 11A, 11B, 12A-12F, 18A, 18B, 19, and 20. Further, the processor 120 can be configured to implement various embodiments of the neural networks outlined herein, e.g., as in FIGS. 3A-3D, 4A and 4B, 8A-8D, 13A-13C, or 17A-17D.

Network interface(s) 110 include the mechanical, electrical, and signaling circuitry for communicating data over the communication links coupled to a communication network. Network interfaces 110 are configured to transmit and/or receive data using a variety of different communication protocols. As illustrated, the box representing network interfaces 110 is shown for simplicity, and it is appreciated that such interfaces may represent different types of network connections such as wireless and wired (physical) connections. Network interfaces 110 are shown separately from power supply 160, however it is appreciated that the interfaces that support PLC protocols may communicate through power supply 160 and/or may be an integral component coupled to power supply 160.

Memory 140 includes a plurality of storage locations that are addressable by processor 120 and network interfaces 110 for storing software programs and data structures associated with the embodiments described herein. In some embodiments, device 100 may have limited memory or no memory (e.g., no memory for storage other than for programs/processes operating on the device and associated caches). Memory 140 can include instructions executable by the processor 120 that, when executed by the processor 120, cause the processor 120 to implement aspects of the system and the methods outlined herein.

Processor 120 comprises hardware elements or logic adapted to execute the software programs (e.g., instructions) and manipulate data structures 145. An operating system 142, portions of which are typically resident in memory 140 and executed by the processor, functionally organizes device 100 by, inter alia, invoking operations in support of software processes and/or services executing on the device. These software processes and/or services may include macrostate-microstate determination processes/services 190. Note that while macrostate-microstate determination processes/services 190 is illustrated in centralized memory 140, alternative embodiments provide for the process to be operated within the network interfaces 110, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the macrostate-microstate determination processes/services 190 is shown as a standalone process, those skilled in the art will appreciate that this process may be executed as a routine or module within other processes.

### 8. Methods

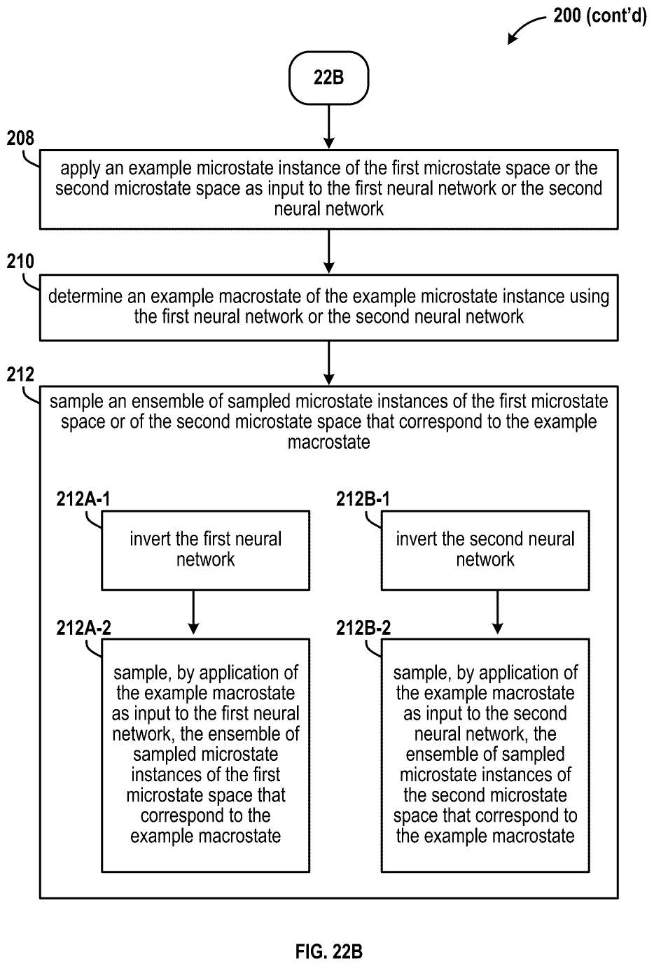

FIGS. 22A and 22B show a method 200 for implementation of the concepts outlined herein by a computing device, e.g., device 100 shown in FIG. 21.

Referring to FIG. 22A, step 202 of method 200 includes providing a set of training data as input to a first neural network and a second neural network, the set of training data including a plurality of training microstate pairs, where each respective training microstate pair of the plurality of training microstate pairs includes a first training microstate instance belonging to a first microstate space and a second training microstate instance belonging to a second microstate space. The first microstate space and the second microstate space can each include observation data about a physical system, where the first microstate space corresponds with a first type of observation data about the physical system, and where the second microstate space corresponds with a second type of observation data about the physical system.

Step 204 of method 200 includes jointly training the first neural network to learn a first mapping between the first microstate space and a first macrostate and training the second neural network to learn a second mapping between the second microstate space and a second macrostate using the set of training data, such that a difference between the first macrostate and the second macrostate is minimized for each training microstate pair of the plurality of training microstate pairs of the set of training data. In particular, step 204 can include step 206, which includes iteratively determining parameters of the first neural network and the second neural network that minimize a loss function incorporating: a prediction loss between results of the first mapping and the second mapping for each training microstate pair of the plurality of training microstate pairs, where the first microstate space is related to the second microstate space by a joint distribution; and a distribution loss that enforces the first mapping and the second mapping to each have a nonzero Jacobian determinant.

The prediction loss and the distribution loss collectively result in mappings that are compatible and that connect the first microstate space to the second microstate space by their relationships with the first macrostate and the second macrostate (which are enforced to be as substantially equivalent as possible), while simultaneously ensuring that the macrostates are non-trivial. Further, the use of invertible neural networks simplifies calculation of the Jacobian determinant, which is normally a computationally-expensive process. Further, note that the first microstate space follows a conditional distribution where values of an ensemble of first microstate instances of the first microstate space are contingent upon the second macrostate, and the second microstate space follows a conditional distribution where values of an ensemble of second microstate instances of the second microstate space are contingent upon the first macrostate.

FIG. 22A concludes at (22B).

Steps 208-212 start at (22B) of FIG. 22B and focus on “sampling” of microstates using the identified mappings that represent macrostates. Step 208 of method 200 includes applying an example microstate instance of the first microstate space or the second microstate space as input to the first neural network or the second neural network. Step 210 of method 200 includes determining an example macrostate of the example microstate instance using the first neural network or the second neural network (e.g., depending on whether the example microstate instance belongs to the first microstate space or the second microstate space). Step 212 of method 200 includes sampling an ensemble of sampled microstate instances of the first microstate space or of the second microstate space that correspond to the example macrostate.

Step 212 can include various sub-steps, and the details of which can depend on whether the ensemble of sampled microstate instances that is sought belongs to the first microstate space or the second microstate space.

Steps 212a-1 and 212a-2 pertain to when the ensemble of sampled microstate instances belongs to the first microstate space. Step 212a-1 includes inverting the first neural network (or otherwise accessing an inverted version of the first neural network). Step 212a-2 includes sampling, by application of the example macrostate as input to the first neural network, the ensemble of sampled microstate instances of the first microstate space that correspond to the example macrostate. Likewise, step 212b-1 includes inverting the second neural network (or otherwise accessing an inverted version of the second neural network). Step 212b-2 includes sampling, by application of the example macrostate as input to the second neural network, the ensemble of sampled microstate instances of the second microstate space that correspond to the example macrostate.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

1. A system, comprising:
a processor in communication with a memory, the memory including instructions executable by the processor to:
apply an example microstate instance of a microstate space as input to a neural network to obtain an example macrostate of the example microstate instance, the neural network being one of a first neural network having learned a first mapping between a first microstate space of a microstate pair and a first macrostate, and a second neural network having learned a second mapping between a second microstate space of the microstate pair and a second macrostate;
the first microstate space and the second microstate space each including observation data about a physical system, where the first microstate space corresponds with a first type of observation data about the physical system, and where the second microstate space corresponds with a second type of observation data about the physical system; and
sample, by the neural network, an ensemble of sampled microstate instances of the first microstate space or the second microstate space that correspond to the example macrostate, the neural network being an invertible neural network.

2. The system of claim 1, the memory further including instructions executable by the processor to:
provide a set of training data as input to the first neural network and the second neural network, the set of training data including a plurality of training microstate pairs, where each respective training microstate pair of the plurality of training microstate pairs includes a first training microstate instance belonging to the first microstate space and a second training microstate instance belonging to the second microstate space; and
jointly train the first neural network to learn the first mapping and train the second neural network to learn the second mapping using the set of training data, such that a difference between the first macrostate and the second macrostate is minimized for each training microstate pair of the plurality of training microstate pairs of the set of training data.

3. A method, comprising:
applying an example microstate instance of a microstate space as input to an neural network to obtain an example macrostate of the example microstate instance, the neural network being one of a first neural network having learned a first mapping between a first microstate space of a microstate pair and a first macrostate, and a second neural network having learned a second mapping between a second microstate space of the microstate pair and a second macrostate; and
sampling, by the neural network, an ensemble of sampled microstate instances of the first microstate space or the second microstate space that correspond to the example macrostate, the neural network being an invertible neural network.

4. The method of claim 3, further comprising:
sampling, by application of the example macrostate as input to the first neural network, the ensemble of sampled microstate instances of the first microstate space that correspond to the example macrostate of the example microstate instance, the first neural network being a first invertible neural network.

5. The method of claim 4, further comprising:
inverting the first invertible neural network.

6. The method of claim 3, further comprising:
sampling, by application of the example macrostate as input to the second neural network, the ensemble of sampled microstate instances of the second microstate space that correspond to the example macrostate of the example microstate instance, the second neural network being a second invertible neural network.

7. The method of claim 6, further comprising:
inverting the second invertible neural network.

8. The method of claim 3, the first microstate space and the second microstate space each including observation data about a physical system, where the first microstate space corresponds with a first type of observation data about the physical system, and where the second microstate space corresponds with a second type of observation data about the physical system.

9. The method of claim 3, the microstate pair following a joint distribution that relates the first microstate space to the second microstate space.

10. The method of claim 3, further comprising:
providing a set of training data as input to the first neural network and the second neural network, the set of training data including a plurality of training microstate pairs, where each respective training microstate pair of the plurality of training microstate pairs includes a first training microstate instance belonging to the first microstate space and a second training microstate instance belonging to the second microstate space; and
jointly training the first neural network to learn the first mapping between the first microstate space and the first macrostate and training the second neural network to learn the second mapping between the second microstate space and the second macrostate using the set of training data, such that a difference between the first macrostate and the second macrostate is minimized for each training microstate pair of the plurality of training microstate pairs of the set of training data.

11. The method of claim 10, the ensemble of sampled microstate instances of the first microstate space following a conditional distribution where values of the ensemble of sampled first microstate instances are contingent upon the second macrostate, and the ensemble of sampled microstate instances of the second microstate space following a conditional distribution where values of the ensemble of sampled second microstate instances are contingent upon the first macrostate.

12. A method, comprising:
providing a set of training data as input to a first neural network and a second neural network, the set of training data including a plurality of training microstate pairs, where each respective training microstate pair of the plurality of training microstate pairs includes a first training microstate instance belonging to a first microstate space and a second training microstate instance belonging to a second microstate space;
the first microstate space and the second microstate space each including observation data about a physical system, where the first microstate space corresponds with a first type of observation data about the physical system, and where the second microstate space corresponds with a second type of observation data about the physical system; and
jointly training the first neural network to learn a first mapping between the first microstate space and a first macrostate and training the second neural network to learn a second mapping between the second microstate space and a second macrostate using the set of training data, such that a difference between the first macrostate and the second macrostate is minimized for each training microstate pair of the plurality of training microstate pairs of the set of training data.

13. The method of claim 12, where jointly training the first neural network and the second neural network includes iteratively determining parameters of the first neural network and the second neural network that minimize a loss function incorporating a prediction loss between results of the first mapping and the second mapping for each training microstate pair of the plurality of training microstate pairs, where the first microstate space is related to the second microstate space by a joint distribution.

14. The method of claim 12, where jointly training the first neural network and the second neural network includes iteratively determining parameters of the first neural network and the second neural network that minimize a loss function incorporating a distribution loss that enforces the first mapping and the second mapping to each have a nonzero Jacobian determinant.

15. The method of claim 12, the first microstate space following a conditional distribution where values of an ensemble of first microstate instances of the first microstate space are contingent upon the second macrostate, and the second microstate space following a conditional distribution where values of an ensemble of second microstate instances of the second microstate space are contingent upon the first macrostate.

16. The method of claim 12, further comprising:
applying an example microstate instance of the first microstate space or the second microstate space as input to the first neural network or the second neural network;
determining an example macrostate of the example microstate instance using the first neural network or the second neural network; and
sampling an ensemble of sampled microstate instances of the first microstate space or of the second microstate space that correspond to the example macrostate.

17. The method of claim 16, further comprising:
sampling, by application of the example macrostate as input to the first neural network, the ensemble of sampled microstate instances of the first microstate space that correspond to the example macrostate, the first neural network being a first invertible neural network.

18. The method of claim 17, further comprising:
inverting the first invertible neural network.

19. The method of claim 16, further comprising:
sampling, by application of the example macrostate as input to the second neural network, the ensemble of sampled microstate instances of the second microstate space that correspond to the example macrostate, the second neural network being a second invertible neural network.

20. The method of claim 19, further comprising:
inverting the second invertible neural network.
